(19) United States
(12) Patent Application Publication
(10) Pub. No.: US 2007/0229647 A1
(43) Pub. Date: Oct. 4, 2007

(54) IMAGE FORMING APPARATUS

(75) Inventors: Yuuzou KAWANO, Fukuoka (JP); Kouhei SUYAMA, Fukuoka (JP); Kazuo NISHIMURA, Fukuoka (JP); Yuuji TOYOMURA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/691,724

(22) Filed: Mar. 27, 2007

(30) Foreign Application Priority Data
Mar. 28, 2006 (JP) 2006-088630

(51) Int. Cl. B41J 2/435

(52) U.S. Cl. 347/224

(57) ABSTRACT

When a driving current value of at least one light emitting element (an organic EL element) has reached a correction limit current value, a controller CPU of a controller constituting a light intensity correcting unit does not correct the light intensity of the light emitting element. Alternatively, the controller CPU may correct the light intensity of the light emitting elements other than a reference light emitting element on the basis of the light intensity of the reference light emitting element using the light element of which the driving current value is greatest as the reference light emitting element. Alternatively, the controller CPU may correct the light intensity of the light emitting elements other than a reference light emitting element on the basis of the light intensity of the reference light emitting element, using the light emitting element of which the light intensity is smallest when the entire light emitting elements are driven with the same driving condition as the reference light emitting element.

### BACKGROUND OF THE INVENTION

1. Field of the Invention

The present invention relates to an image forming apparatus equipped with an exposure device having a light emitting element array constituted by aligning a plurality of light emitting elements in an array configuration, and more particularly, to an image forming apparatus capable of correcting the light intensity of light emitting elements of an exposure device.

2. Description of the Related Art

In an exposure device used in an image forming apparatus employing a so-called electro-photographic process, a photosensitive member charged with a predetermined electric potential is exposed in accordance with image information to form an electrostatic latent image, the electrostatic latent image is developed with a toner, and the developed toner image is transferred and fused on a recording paper, thereby printing an image on the recording paper. As a method of forming the electrostatic latent image in the exposure device, there is known a method in which light beams emitted from a laser diode serving as a light source are irradiated on a photosensitive member through a rotatory polygonal mirror called a polygon mirror, thereby forming the electrostatic latent image on the photosensitive member, and a method in which light emitting portions of a light emitting element array constituted by aligning light emitting elements composed of light-emitting diodes (hereinafter referred to as an LED) or organic EL elements in an array configuration are individually lighted (ON/OFF) so as to form the electrostatic latent image on the photosensitive member.

In the exposure device including the light emitting element array composed of the LEDs or the organic EL elements as a component, light emitting elements are selectively lighted in the proximity of the photosensitive member so as to irradiate exposure light on the photosensitive member. Therefore, the image forming apparatus equipped with such an exposure device does not have a moving part such as the polygon mirror which is required in the image forming apparatus using the laser diode, and thus can be operated with high reliability and quietness. In addition, since it does not require an optical system for introducing light beams output from the laser diode to the photosensitive member and a large optical space serving as an optical path, it is possible to downsize the image forming apparatus.

Particularly, in the exposure device having the organic EL elements as the light emitting element, the organic EL elements and a drive circuit constituted by switching elements composed of thin film transistors (hereinafter referred to as a TFT) can be integrally formed on a substrate such as a glass substrate. Therefore, a manufacturing process is simplified, and it is possible to achieve a further downsizing and a cost reduction, compared with the exposure device having the LED as the light emitting element.

On the other hand, it has been known that so-called light intensity deterioration is found in the organic EL elements, i.e., the brightness gradually decreases with the driving of the organic EL element. The organic EL elements employed in a general display apparatus have a brightness of around 1000 [cd/m²]. To the contrary, when it is assumed that the image forming apparatus has a specification of 600 dpi (dots per inch) and 20 ppm (pages per minute), the organic EL elements employed in the exposure device installed in the image forming apparatus such as an electro-photographic apparatus require a brightness of 10000 [cd/m²] or more. Accordingly, a strict driving condition of high voltage and large current is required. Therefore, the organic EL elements employed in the exposure device are likely to be influenced by the light intensity deterioration compared with that employed in the display apparatus, and it is thus necessary to correct the exposure light intensity in order to maintain individual exposure light intensity of the organic EL elements at a state equivalent to an initial state.

Moreover, it has been known that the brightness of the organic EL elements shows a temperature dependency. The temperature dependency is determined by the organic material constituting the organic EL elements and may have positive or negative characteristics. The image forming process of the above-mentioned electro-photographic apparatus includes a process of fixing the toner image onto the recording paper with heat and pressure, and the apparatus includes a heat source capable of generating a large amount of heat. Therefore, the brightness of the organic EL elements changes with the variation in the internal temperature of the apparatus. Even in this case, it is necessary to correct the individual exposure light intensity of the organic EL elements.

Moreover, since it is difficult to prevent an uneven brightness distribution between individual organic EL elements, it is necessary to correct the exposure light intensity so as to prevent an uneven exposure light intensity distribution between elements.

As an arrangement for correcting the exposure light intensity in the image forming apparatus equipped with the exposure device employing the conventional organic EL element, there is known an arrangement disclosed in JP-A-2004-082330, for example. The exposure device disclosed in JP-A-2004-082330 is configured such that light receiving sensors are arranged on a glass substrate having the organic EL elements formed thereon and the exposure light intensity of the organic EL elements are detected by the light receiving sensors.

According to the exposure device disclosed in JP-A-2004-082330, the exposure light intensity Pgn of the n-th organic EL element is measured in advance in a test jig, and the exposure light intensity Phn is measured by the above-mentioned light receiving sensor, thereby calculating a correction coefficient Pgn/Phn on the basis of the exposure-light intensity Pgn and Phn. Then, the correction coefficient is stored in a storing unit installed in the exposure device or the image forming apparatus. After the exposure device is mounted on the image forming apparatus, a new driving current or the like of the organic EL elements is determined on the basis of the light intensity detection result of the light receiving sensor and the correction coefficient stored in the storing unit. Accordingly, it is possible to always maintain the initial exposure light intensity of the organic EL elements.

Moreover, according to JP-A-2004-082330, the operation of correcting the exposure light intensity can be performed in accordance with a command from a printer controller at any point of time such as in an initialization time just after the start-up of the image forming apparatus, before printing operation, an inter-paper period.

In the above-mentioned image forming apparatus, it is necessary to control the light intensity (brightness) of the organic EL elements in the exposure device to be equal to each other in order to make the exposure light intensity on the photosensitive member equal to each other. As described above, since the light intensity of the organic EL elements gradually decreases with the driving, the values of the voltage and the current (current density) applied to the organic EL element of which the light intensity has decreased with the lapse of time are controlled to be increased.

However, since there is a limit in increasing the current value and it is difficult to increase the current value to a value equal to or greater than a certain limit current value, it becomes actually impossible to perform a light intensity increasing correction operation to the element having reached such a limit current value (light intensity non-correctable state). In such a situation, it is difficult to form the electrostatic latent image on the photosensitive member and it is thus necessary to stop an engine or the apparatus at that moment. Particularly, when such a situation arises during the printing operation, it is unable to perform a subsequent printing operation, thereby making the treatment inconvenient.

### SUMMARY OF THE INVENTION

An object of the invention is to provide an image forming apparatus capable of preventing an abrupt stoppage of an engine or an apparatus even when a light emitting element fell into a state that the light intensity thereof cannot be corrected, thereby improving usability of the image forming apparatus.

An image forming apparatus according to the invention includes an image carrier; an exposure unit having a plurality of light emitting elements exposing the image carrier to light beams; a light intensity measuring unit measuring a light intensity of light emitted from the light emitting elements; and a light intensity correcting unit setting a driving condition for the light emitting elements on the basis of the light intensity of light measured by the light intensity measuring unit, which is emitted from the light emitting elements, wherein the light intensity correcting unit is configured to correct the light intensity of light emitted from the light emitting elements other than a reference light emitting element on the basis of the light intensity of light emitted from the reference light emitting element, using the light emitting element of which the driving condition is closet to a correction limit as the reference light emitting element.

In the following description, “the light intensity of light emitted from the light emitting elements” may be simply referred to as “the light intensity of light emitting elements.”

As an alternative example, the image forming apparatus may be configured such that the light intensity correcting unit corrects the light intensity of light emitted from the light emitting elements other than a reference light emitting element on the basis of the light intensity of light emitted from the reference light emitting element, using the light emitting element of which the driving condition set by the light intensity correcting unit has reached a correction limit as the reference light emitting element.

As another alternative example, the image forming apparatus may be configured such that the light intensity correcting unit corrects the light intensity of light emitted from the light emitting elements other than a reference light emitting element on the basis of the light intensity of light emitted from the reference light emitting element, using the light emitting element of which the light intensity is smallest when the entire light emitting elements are driven with the same driving condition as the reference light emitting element.

As a further alternative example, the image forming apparatus may be configured such that the light intensity correcting unit does not correct the light intensity of light emitted from the light emitting element of which the driving condition set by the light intensity correcting unit satisfies a predetermined condition.

In the above-mentioned image forming apparatus, the driving condition may be selected from any one of the driving current, the driving voltage, and the driving time for driving the light emitting elements. Moreover, the predetermined condition or the correction limit may be that a setting value to be set by the light intensity correcting unit corresponding to any one of a driving current value, a driving voltage value, and a driving time of the light emitting element has reached a predetermined value.

An image forming apparatus according to the invention includes a photosensitive member; a charger charging a surface of the photosensitive member; a plurality of light emitting elements irradiating light beams to the surface of the photosensitive member charged by the charger, thereby exposing the surface to the light beams so as to form an electrostatic latent image on the surface; a development unit applying a developing agent onto the electrostatic latent image so as to develop the electrostatic latent image; a light intensity measuring unit measuring a light intensity of light emitted from the light emitting elements; and a light intensity correcting unit setting a driving condition for the light emitting elements on the basis of the light intensity of light measured by the light intensity measuring unit, which is emitted from the light emitting elements, wherein the light intensity correcting unit is configured to, when there is at least one correction limit light emitting element of which the driving current value has reached a correction limit current value, do not correct the light intensity of light emitted from the correction limit light emitting element.

According to the image forming apparatus of the invention, it is possible to prevent an abrupt stoppage of an engine or an apparatus even when there is any light emitting element (lifetime element) having reached the correction limit. Accordingly, usability of the image forming apparatus is improved.

In the above-mentioned configuration, the driving current value of the correction limit light emitting element may be maintained at the correction limit current value. Moreover, the light intensity correcting unit may correct the light intensity of light emitted from the light emitting elements other than the correction limit light emitting element on the basis of the light intensity of light emitted from the correction limit light emitting element.

In another image forming apparatus according to the invention, the light intensity correcting unit corrects the light intensity of light emitted from the light emitting elements other than a reference light emitting element on the basis of the light intensity of light emitted from the reference light emitting element, using the light emitting element of which the driving current value set by the light intensity correcting unit is greatest as the reference light emitting element. In such a configuration, it is possible to achieve the same advantage as described above. In this case, the light intensity correcting unit may set the light intensity of light emitted from the reference light emitting element to a second light intensity and correct the light intensity of light emitted from other light emitting elements using the second light intensity.

In still another image forming apparatus according to the invention, the light intensity correcting unit corrects the light intensity of light emitted from the light emitting elements other than a reference light emitting element on the basis of the light intensity of light emitted from the reference light emitting element, using the light emitting element of which the light intensity is smallest when the entire light emitting elements are driven by the same driving current value as the reference light emitting element. In such a configuration, it is possible to achieve the same advantage as described above.

In addition, the development bias potential of the development unit may be controlled on the basis of the exposure potential of the electrostatic latent image corresponding to the light intensity of light emitted from the reference light emitting element. Moreover, the charging potential of the charger for charging the photosensitive member may be controlled on the basis of the exposure potential of the electrostatic latent image corresponding to the light intensity of light emitted from the reference light emitting element. With such a configuration, it is possible to maintain printing quality even when the light intensity of the entire light emitting elements is changed.

The image forming apparatus according to the invention may further include an alarm device notifying that the driving current value of the correction limit light emitting element or the reference light emitting element has reached a predetermined current value.

According to the image forming apparatus related to the invention, it is possible to prevent an abrupt stoppage of an engine or an apparatus even when there is any light emitting element (lifetime element) having reached the correction limit. Accordingly, usability of the image forming apparatus is improved.

### BRIEF DESCRIPTION OF THE DRAWINGS

FIG. 1 is a diagram showing a configuration of an image forming apparatus according to a basic embodiment of the invention.

FIG. 2 is a diagram showing a peripheral configuration of a development station of the image forming apparatus according to the embodiment.

FIG. 3 is a diagram showing a configuration of an exposure device of the image forming apparatus according to the embodiment.

FIG. 4A is a top view of a glass substrate related to the exposure device of the image forming apparatus according to the embodiment, and FIG. 4B is an enlarged view of a main part thereof.

FIG. 5 is a block diagram showing a configuration of a controller of the image forming apparatus according to the embodiment.

FIG. 6 is an explanatory diagram showing a content of a light intensity data memory of the image forming apparatus according to the embodiment.

FIG. 7 is a block diagram showing a configuration of an engine control unit of the image forming apparatus according to the embodiment.

FIG. 8 is a circuit diagram showing the exposure device of the image forming apparatus according to the embodiment.

FIG. 9 is an explanatory diagram showing a current programming period related to the exposure device of the image forming apparatus according to the embodiment and a lighting and non-lighting period of an organic EL element.

FIG. 10 is a diagram showing an organic EL element and a drive circuit of a corresponding light intensity sensor.

FIG. 11 is a diagram showing a connection relation between a sensor pixel circuit and a charge amplifier 150 and an operational relation between a light intensity sensor and an organic EL element.

FIG. 12 is a timing chart showing operations of each part shown in FIG. 11.

FIG. 13 is a timing chart showing timing for performing a light intensity measurement for a light intensity correction.

FIG. 14 is a graph showing variations with the lapse of time in applied voltage and current values required for maintaining a constant light intensity of an organic EL element.

FIG. 15 is a conceptual diagram showing a current value, an initial current value, and a correction limit current value of each element at a certain time point.

FIG. 16 is a diagram showing an example of decreasing a surface potential of a photosensitive member using a charger and an example of increasing a development bias potential.

FIG. 17 is a conceptual diagram showing a current value, an initial current value, and a correction limit current value of each element at a certain time point, in which a light emitting element having a maximum current value serves as a correction reference.

FIG. 18 is a conceptual diagram showing a current value, an initial current value, and a correction limit current value of each element at a certain time point, in which a light emitting element having a minimum light intensity serves as a correction reference.

### DESCRIPTION OF THE PREFERRED EMBODIMENTS

Hereinafter, embodiments related to a basic configuration of the invention will be described with reference to drawings.

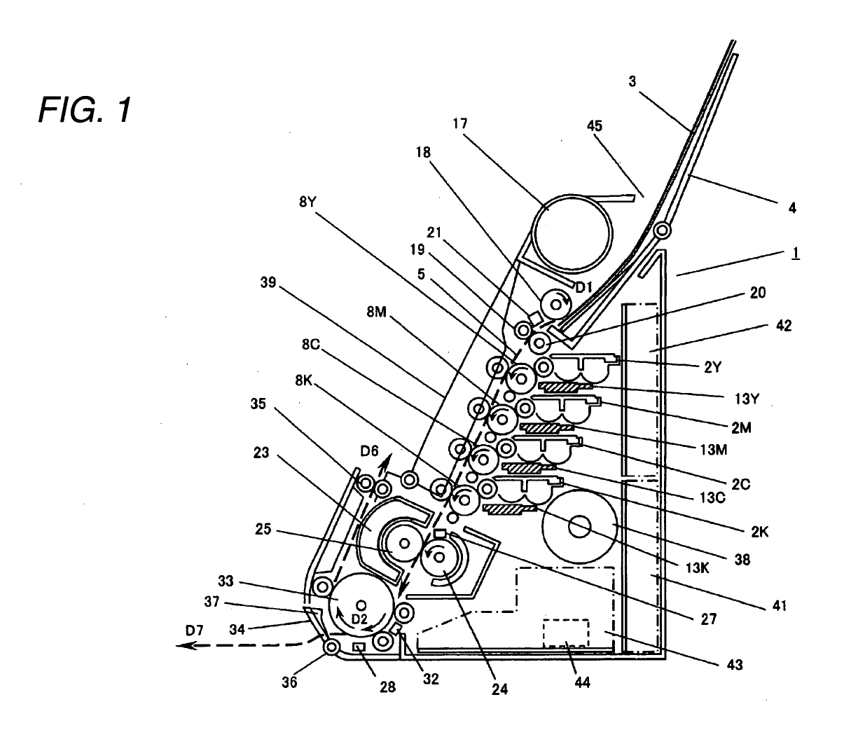

FIG. 1 is a diagram showing a configuration of an image forming apparatus related to an embodiment of the invention. In FIG. 1, the image forming apparatus 1 includes four development stations corresponding to four colors, i.e., a yellow development station 2Y, a magenta development station 2M, a cyan development station 2C, and a black development station 2K, which are arranged with an offset in a longitudinal direction. A paper feeding tray 4 accommodating a recording paper 3 as a recording medium therein is disposed above the development stations 2Y to 2K. At locations corresponding to the individual development stations 2Y to 2K, a recording paper conveyance path 5 serving as a conveyance path of the recording paper 3 supplied from the paper feeding tray extends in a longitudinal direction from an upstream side to the downstream side.

Each of the development stations 2Y to 2K forms a toner image of yellow, magenta, cyan, and black colors in this order from the upstream side of the recording paper conveyance path 5. The yellow development station 2Y has a photosensitive member 8Y, the magenta development station 2M has a photosensitive member 8M, the cyan development station 2C has a photosensitive member 8C, and the black development station 2K has a photosensitive member 8K. Moreover, each of the development stations 2Y to 2K includes components for performing a development process of a series of electro-photographic process, such as a development sleeve and a charger, which will be described later.

Exposure devices 13Y to 13K for exposing the surfaces of the photosensitive members 8Y to 8K so as to form electrostatic latent images are respectively disposed below each of the development stations 2Y to 2K.

Although colors of developing agents filled in the development stations 2Y to 2K are different from each other, the configurations of the development stations are equal to each other regardless of the developing agent color. Therefore, in the following descriptions, the development stations, the photosensitive members, and the exposure devices will be simply denoted by a development station (development unit) 2, a photosensitive member 8, and an exposure device 13 without including a specific color thereof in order to simplify the description, except a case where there is especially a need to state clearly.

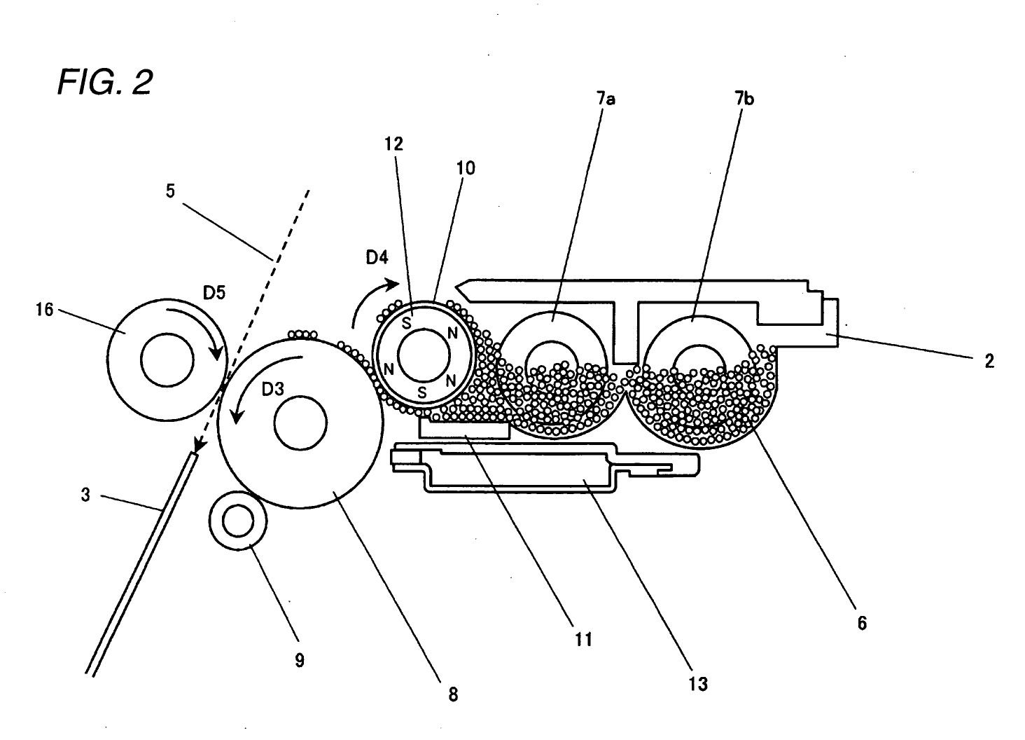

FIG. 2 is a diagram showing a peripheral configuration of the development station 2 of the image forming apparatus 1 according to the invention. In FIG. 2, a developing agent 6 as a mixture of a carrier and a toner is filled in the development station 2. Reference numerals 7a and 7b denotes stirring paddles for stirring the developing agent 6. With the rotation of the stirring paddles 7a and 7b, the toner in the developing agent 6 is charged with a predetermined electric potential by the friction with the carrier, and the toner and the carrier are sufficiently stirred and mixed while being circulated in the development station 2. The photosensitive member 8 is rotated in the D3 direction by a driving source (not shown). Reference numeral 9 denotes a charger that charges the surface of the photosensitive member 8 with a predetermined electric potential. Reference numeral 10 denotes a development sleeve and reference numeral 11 denotes a thin-layered blade. The development sleeve includes a magenta roll 12 having a plurality of magnetic poles arranged therein. The layer thickness of the developing agent 6 supplied and formed on the surface of the development sleeve 10 is regulated by the thin-layered blade 11. The development sleeve 10 is rotated in the D4 direction by a driving source (not shown), the developing agent 6 is supplied to the surface of the development sleeve 10 by the rotation of the development sleeve 10 and the action of the magnetic poles of the magnet roll 12, and the electrostatic latent image formed on the photosensitive member 8 is developed by an exposure device 13 to be described later. In this case, the developing agent 6 that is not transferred to the photosensitive member 8 is collected into the inside of the development station 2.

Reference numeral 13 denotes an exposure device which includes a light emitting element array constituted by aligning organic EL elements serving as an exposure light source in an array configuration with a resolution of 600 dpi (dots per inch). The exposure device 13 can form an electrostatic latent image of the maximum A4 size paper on the photosensitive member 8 charged with the predetermined electric potential by the charger 9 by selectively on and off the organic EL elements in accordance with image data. When the predetermined electric potential (a development bias) is applied to the development sleeve 10, an electric potential gradient is formed between the electrostatic latent image portion and the development sleeve 10. A coulomb force is applied to the toner in the developing agent 6 that is supplied to the surface of the development sleeve 10 and charged with the predetermined electric potential, and only the toner in the developing agent 6 is adhered to the photosensitive member 8, whereby the electrostatic latent image is developed.

As will be described later in detail, the exposure device 13 is provided with a light intensity sensor serving as a light intensity measuring unit for measuring the light intensity of the organic EL elements.

Reference numeral 16 denotes a transfer roller which is disposed at a position opposite to the photosensitive member 8 with the recording paper 5 interposed therebetween and is rotated in the D5 direction by a driving source (not shown). The transfer roller 16 is applied with a predetermined transfer bias and transfers the toner image formed on the photosensitive member 8 onto the recording paper 3 conveyed through the recording paper conveyance path 5.

Next, the description will be continued with reference to FIG. 1.

Reference numeral 17 denotes a toner bottle in which toners of yellow, magenta, cyan, and black are contained. A toner conveyance pipe (not shown) extends from the toner bottle 17 to each of the development stations 2Y to 2K, and the toner is supplied to each of the development stations 2Y to 2K through the toner conveyance pipe.

Reference numeral 18 denotes a paper feeding roller which is rotated in the D1 direction by the control of an electromagnetic clutch (not shown) and feeds the recording paper 3 stacked in the paper feeding tray 4 to the recording paper conveyance path 5.

In the uppermost stream of the recording conveyance path 5 disposed between the paper feeding roller 18 and the transfer portion of the yellow development station 2Y, there are provided a pair of rollers serving as a nip conveyance unit in the inlet side, i.e., a registration roller 19 and a pinch roller 20. The pair of the registration roller 19 and the pinch roller 20 temporarily stops the recording paper 3 conveyed by the paper feeding roller 18 and then conveys the recording paper 3 in the direction of the yellow development station 2Y at a predetermined timing. With the temporal stop, the front end of the recording paper 3 is squeezed in a direction parallel to the axial direction of the pair of the registration roller 19 and the pinch roller 20, thereby preventing inclination of the recording paper 3.

Reference numeral 21 denotes a recording paper pass detection sensor which is constituted by a reflection type sensor (a photo reflector) and detects front and rear ends of the recording paper 3 by the presence and absence of the reflected light.

When the rotation of the registration roller 19 is started with the control of the power transfer using an electromagnetic clutch (not shown), the recording paper 3 is conveyed along the recording paper conveyance path 5 in a direction toward the yellow development station 2Y. However, writing timings for the exposure devices 13Y to 13K disposed in the vicinity of the development stations 2Y to 2K to form the electrostatic latent images, ON/OFF timings for the development bias, ON/OFF timings for the transfer bias and the like are individually controlled at the time of starting the rotation of the registration roller 19.

Next, the description will be continued with reference to FIG. 2.

Since the distance between the exposure device 13 and a development area (vicinities of the narrowest portion between the photosensitive member 8 and the development sleeve 10) is a matter of design, the time period for the latent image formed on the photosensitive member 8 to reach the development area after the exposure device 13 starts its exposing operation is also a matter of design.

In the embodiment, at the time of starting the rotation of the registration roller 19, it is controlled that the organic EL elements constituting the exposure device 13 are lighted with set values of light intensity in a period between papers (i.e., an inter-paper period) successively conveyed through the recording paper conveyance path 5 when successively printing a plurality of papers and the development bias is turned off in a period corresponding to the location of the latent image formed on the photosensitive member 8.

Next, the description will be continued with reference to FIG. 1.

In the lowermost stream of the recording conveyance path 5 disposed at a further downstream side of the black development station 2K, there is provided a fixing unit 23 serving as a nip conveyance unit in the outlet side. The fixing unit 23 is constituted by a heating roller 24 and a pressure roller 25.

Reference numeral 27 denotes a temperature sensor for detecting the temperature of the heating roller 24. The temperature sensor 27 is a ceramic semiconductor mainly composed of a metal oxide, obtained through a high-temperature sintering process. The temperature sensor 27 can measure the temperature of an object being in contact by utilizing the variation in load resistance with temperature. The output of the temperature sensor 27 is supplied to an engine control unit 42 to be described later, the engine control unit 24 controls electric power supplied to a heat source (not shown) installed in the heating roller 24 on the basis of the output of the temperature sensor 27 so that the surface temperature of the heating roller 24 becomes about 170° C.

When the recording paper 3 having the toner image formed thereon passes through the nip portion constituted by the temperature-controlled heating roller 24 and the pressure roller 25, the toner image formed on the recording paper 3 is heated and pressurized by the heating roller 24 and the pressure roller 25 so that the toner image is fixed onto the recording paper 3.

Reference numeral 29 denotes a recording paper rear-end detection sensor that monitors a discharge state of the recording paper 3. Reference numeral 32 denotes a toner image detection sensor which is a reflection type sensor unit constituted by a plurality of light emitting elements having light emitting spectra different from each other (all of which are in a visible band) an a single light receiving element. The toner image detection sensor 32 detects an image density by utilizing a fact that the absorption spectrum at background portions of the recording paper 3 and the absorption spectrum at image forming portions are different from each other in accordance with image colors. Moreover, since the toner image detection sensor 32 can detect an image forming position in addition to the image density, in the image forming apparatus 1 of the embodiment, two toner image detection sensor 32 are provided in the width direction of the image forming apparatus 1 so as to control an image forming timing on the basis of a detection position of the positional error detection pattern of images formed on the recording paper 3.

Reference numeral 33 denotes a recording paper conveyance drum which is a metal roller coated with a rubber having a thickness of 200 um. Fixed recording paper 3 is conveyed in the D2 direction along the recording paper conveyance roller 33. In this case, the recording paper 3 is cooled by the recording paper conveyance drum 33 and is conveyed along a curved line in a direction opposite to the image forming direction. With this arrangement, it is possible to considerably reduce the curl of paper occurring when forming an image on the entire surface of the recording paper with a high density. Then, the recording paper 3 is conveyed in the D6 direction by an outfeed roller 35 and discharged to a paper discharging tray 39.

Reference numeral 34 denotes a face-down paper discharging unit which is pivotable forward and backward about a support member 36. When the face-down paper discharging unit 34 is in an open state, the recording paper 3 is discharged in the D7 direction. A rib 37 is provided along the conveyance path on a back surface of the face-down paper discharging unit 34 so that the rib 37 guides the conveyance of the recording paper 3 in cooperation with the recording paper conveyance drum 33 when the face-down paper discharging unit 34 is in a closed state.

Reference numeral 38 denotes a driving source which is embodied as a stepping motor in the embodiment. The driving source 38 serves to drive the peripheral portions of the development stations 2Y to 2K including the paper feeding roller 18, the registration roller 19, the pinch roller 20, the photosensitive members 8Y to 8K, and the transfer roller 16 (see FIG. 2 for reference), the fixing unit 23, the recording paper conveyance drum 33, and the outfeed roller 35.

Reference numeral 41 denotes a controller which receives image data from a computer (not shown) or the like through an external network and develops and generates printable image data. As will be described later in detail, a controller CPU (not shown) installed in the controller 41 serves not only as a light intensity correcting unit that receives measurement data of the light intensity of the organic EL elements as a light emitting element from the exposure devices 13Y to 13K so as to generate light intensity correction data, but also as a light intensity setting unit that sets the light intensity of the organic EL elements on the basis of the light intensity correction data.

Reference numeral 42 denotes an engine control unit which controls hardware or mechanism of the image forming apparatus 1 so as to form color image on the recording paper 3 on the basis of the image data and the light intensity correction data transmitted from the controller 41. Moreover, the engine control unit 42 controls a general operation of the image forming apparatus 1 including a temperature control of the heating roller 24 of the fixing unit 23.

Reference numeral 43 denotes a power source unit which supplies an electric power of a predetermined voltage to the exposure devices 13Y to 13K, the driving source 38, the controller 41, and the engine control unit 42. The power source unit 43 also supplies an electric power to the heating roller 24 of the fixing unit 23. The power source unit 43 has a high voltage source system such as a charging potential for charging the surface of the photosensitive member 8, a development bias to be applied to the development sleeve 10 (see FIG. 2 for reference), and a transfer bias to be applied to the transfer roller 16. The engine control unit 42 regulates turning on and off, an output voltage value, and an output current value of the high voltage source by controlling the power source unit 43.

Moreover, the power source unit 43 has a power source monitor unit 44 which allows monitoring of a power source voltage to be supplied to the engine control unit 42, the output voltage of the power source unit 43, and the like. The monitor signal is detected by the engine control unit 42 in which a voltage drop in the power source caused by a switching-off or a stoppage of power supply or the like or, especially, an abnormal output of the high voltage source is detected.

Next, the operation of the image forming apparatus 2 having such an arrangement will be described with reference to FIGS. 1 and 2.

In the following description, when describing the configuration and a general operation of the image forming apparatus 1, FIG. 1 is mainly referenced and the colors are distinguished like the development stations 2Y to 2K, the photosensitive members 8Y to 8K, and the exposure devices 13Y to 13K. However, in the descriptions related to a single color, such as an exposure process and a development process, FIG. 2 is mainly referenced and the colors are not distinguished like the development station 2, the photosensitive member 8, and the exposure device 13.

<Initialization Operation>

First, an initialization operation at the time of supplying power to the image forming apparatus 1 will be described.

When power is supplied to the image forming apparatus 1, an engine control CPU (not shown) installed in the engine control unit 42 checks errors in electric resources constituting the image forming apparatus 1, i.e., registers and memories. When the error checking is completed, the engine control CPU (not shown) starts rotation of the driving source 38. As described above, the peripheral portions of the development stations 2Y to 2K including the paper feeding roller 18, the registration roller 19, the pinch roller 20, the photosensitive members 8Y to 8K, and the transfer roller 16 (see FIG. 2 for reference), the fixing unit 23, the recording paper conveyance drum 33, and the outfeed roller 35 are driven by the driving source 38. However, immediately after the supply of power, the electromagnetic clutch (not shown) transferring a driving force to the paper feeding roller 18 and the registration roller 19 related to the conveyance of the recording paper 3 is immediately set to an OFF state so that the paper feeding roller 18 and the registration roller 19 are controlled not to convey the recording paper 3.

Next, the description will be continued with reference to FIG. 2.

The rotation of the stirring paddles 7a and 7b and the development sleeve 10 is started in accordance with the rotation of the driving source 38 (see FIG. 1 for reference). Accordingly, the developing agent 6 composed of a toner and a carrier filled in the development station 2 is circulated in the development station 2, and the toner is charged with minus charges by the friction with the carrier.

The engine control CPU (not shown) controls the power source unit 43 (see FIG. 1 for reference) so as to turn on the charger 9 when a predetermined time period has passed after the time of starting the rotation of the driving source 38 (see FIG. 1 for reference). The surface of the photosensitive member 8 is charged with an electric potential of −650 V, for example. The photosensitive member 8 is rotated in the D3 direction, and the engine control CPU (not shown) applies a development bias of −250 V, for example, to the development sleeve 10 by controlling the power source unit 43 (see FIG. 1 for reference) after the charged area has reached the development area, i.e., the narrowest portion between the photosensitive member 8 and the development sleeve 10. In this case, since the surface of the photosensitive member 8 is charged with the electric potential of −650 V and the development sleeve 10 is applied with the development bias of −250 V, the coulomb force applied to the toner charged with minus charges is directed toward the photosensitive member 8 from the development sleeve 10 so that the electromagnetic force line is extended toward the photosensitive member 8 from the development sleeve 10. Therefore, the toner is not adhered to the photosensitive member 8.

As described above, the power source unit 43 (see FIG. 1 for reference) has a function of monitoring the abnormal output (for example, leakage) of the high voltage source, and the engine control CPU (not shown) has a function of checking errors caused at the time of applying the high voltage to the charger 9 or the development sleeve 10.

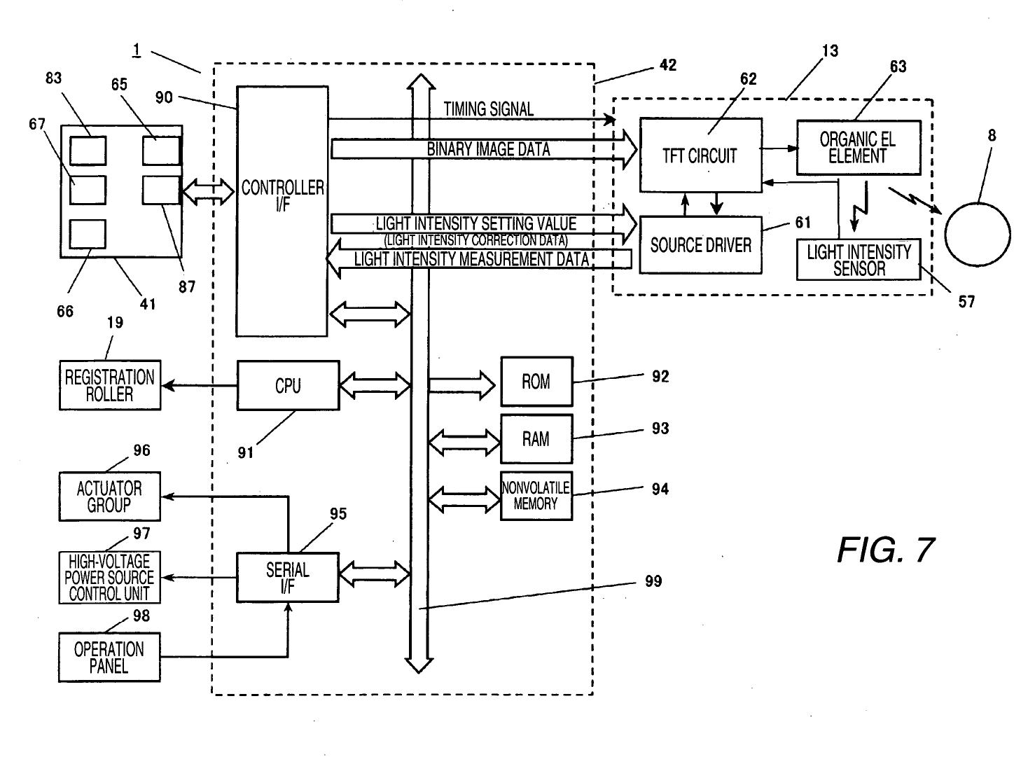

The engine control CPU 91 (see FIG. 7 for reference) corrects the light intensity of the exposure device 13 as a final step of these series of initialization operations or at a predetermined timing to be described later. The engine control CPU 91 installed in the engine control unit 42 (see FIG. 1 for reference) outputs a creation request of dummy image information for the light intensity correction to the controller 41 (see FIG. 1 for reference). Then, the controller 41 (see FIG. 1 for reference) generates the dummy image information for the light intensity correction in accordance with the creation request, and the organic EL elements constituting the exposure device 13 is actually controlled to be lighted or unlighted at the time of initialization on the basis of the dummy image information for the light intensity correction.

As will be described later in detail, the image forming apparatus 1 related to the invention includes the exposure device 13 having a light emitting element array constituted by aligning a plurality of light emitting elements (the organic EL elements) in an array configuration, in which the exposure device 13 exposes the photosensitive member 8 as an image bearing member so as to form an image. The image forming apparatus 1 has a light intensity setting unit (the above-mentioned controller CPU-installed in the controller 41) which sets the light intensity of the light emitting elements (the organic EL elements) and a light intensity measuring unit (the above-mentioned light intensity sensor provided to the exposure device 13) which measures the light intensity of the light emitting elements (the organic EL elements).

In addition, the image forming apparatus 1 related to the invention includes the exposure device 13 having a light emitting element array constituted by aligning a plurality of light emitting elements (the organic EL elements) in an array configuration, the photosensitive member 8 having a latent image formed thereon by the exposure device 13, and the development unit (the development sleeve 10 constituting the development station 2) which develops the latent image formed on the photosensitive member 8 so as to generate a developed image. The image forming apparatus 1 has a light intensity setting unit (the above-mentioned controller CPU installed in the controller 41) which sets the light intensity of the light emitting elements (the organic EL elements) and a light intensity measuring unit (the above-mentioned light intensity sensor provided to the exposure device 13) which measures the light intensity of the light emitting elements (the organic EL elements), which will be described later in detail.

As will be described later in detail, the organic EL elements serving as an exposure light source constituting the exposure device 13 are lighted at a predetermined timing and the light intensity of the organic EL elements is measured. Therefore, even when the light intensity of the organic EL elements or the exposure light intensity to the photosensitive member is corrected, the toner is not adhered to the photosensitive member 8, thereby preventing useless consumption of the toner. In addition, even in the image forming process subsequent to the initialization operation in which the toner is adhered to the transfer roller 16 rotating in contact with the photosensitive member 8, it is possible to prevent the toner adhered to the transfer roller 16 from adhering to the back surface of the recording paper 3 and thus contaminating the recording paper 3.

It is desirable that the development bias applied to the development sleeve 10 is set to an OFF state when the portion of the photosensitive member 8 exposed by the organic EL elements being lighted at the time of correcting the light intensity approaches the development sleeve 10 and passes through the development area. That is, it is desirable that the development bias applied to the development sleeve 10 corresponding to the portion of the photosensitive member 8 exposed at the time of measuring the light intensity of the organic-EL-elements is set to an OFF state. With this arrangement, it is possible to further effectively prevent the adhering of the toner to the photosensitive member 8.

<Image Forming Operation>

Next, the image forming operation of the image forming apparatus 1 will be described with reference to FIGS. 1 and 2.

When image information is transmitted to the controller 41 form an external source, the controller 41 expands the image information to printable data, for example binary image data and supplies the printable data to an image memory (not shown). After completing the expansion of the image information, the controller CPU (not shown) installed in the controller 41 outputs a start-up request to the engine control unit 42. The start-up request is received by the engine control CPU (not shown) installed in the engine control unit 42, and the engine control CPU (not shown) immediately starts the preparation of image forming operation by rotating the driving source 38.

After completing the preparation of the image forming operation through the above-mentioned processes, the engine control CPU (not shown) installed in the engine control unit 42 controls the electromagnetic clutch (not shown) so as to rotate the paper feeding roller 18 and start the conveyance of the recording paper 3. The paper feeding roller 18 is a half-moon shaped roller in which a portion of the entire circumference is omitted. The paper feeding roller 18 conveys the recording paper 3 in the direction of the registration roller 19 and stops its rotation after one rotation. When the front end of the conveyed recording paper 3 is detected by the recording paper pass detection sensor 21, the engine control CPU (not shown) controls the electromagnetic clutch (not shown) so as to rotate the registration roller 19 after a predetermined delay period. The recording paper 3 is supplied to the recording paper conveyance path 5 in accordance with the rotation of the registration roller 19.

The engine control CPU (not shown) individually controls the wiring timing for each of the exposure devices 13Y to 13K to form the electrostatic latent image at the time of starting the rotation of the registration roller 19. Since the writing timing of the electrostatic latent image has a direct influence on the color error or the like of the image forming apparatus 1, the writing timing is not generated directly from the engine control CPU (not shown). Specifically, the engine control CPU (not shown) presets the writing timing for each of the exposure devices 13 to form the electrostatic latent image to timers as hardware (not shown) and activates the operations of the corresponding timers of the exposure devices 13Y to 13K at the time of starting the rotation of the above-mentioned registration roller 19. Each of the timers outputs an image data transmit request to the controller 41 when a preset time period has passed.

The controller CPU (not shown) of the controller 41 having received the image data transmit request transmits individual binary image data to each of the exposure device 13Y to 13K in synchronization with a timing signal (such as a clock signal and a line sync signal) generated from a timing generation unit (not shown) of the controller 41. In this way, the binary image data is sent to the exposure devices 13Y to 13K, and the lighting and non-lighting of the organic EL elements constituting the exposure devices 13Y to 13K is controlled on the basis of the binary image data, thereby exposing the photosensitive members 8Y to 8K corresponding to each color.

The latent image formed by the exposure is developed with the toner contained in the developing agent 6 supplied onto the development sleeve 10, as shown in FIG. 2. The developed toner image corresponding to each color is sequentially transferred to the recording paper 3 conveyed through the recording paper conveyance path 5. The recording paper 3 having toner images corresponding to four colors transferred thereto is conveyed to the fixing unit 23 while being sandwiched between the over-heated roller 24 and the pressure roller 25 constituting the fixing unit 23, and the toner image is then fixed onto the recording paper 3 by the heat and pressure.

In a case where the image is to be formed on a plurality of pages, the engine control CPU (not shown) temporarily stops the rotation of the registration roller 19 when the rear end of the recording paper 3 corresponding to a first page is detected by the recording paper pass detection sensor 21. Thereafter, the engine control CPU starts the conveyance of a subsequent recording paper 3 after a predetermined time period. Similarly, the engine control CPU starts again the rotation of the registration roller 19 after a predetermined time period and then supplies the recording paper 3 corresponding to the next page to the recording paper conveyance path 5. In this way, by controlling the rotation ON and OFF timing of the registration roller 19, it is possible to set the period between recording papers 3 when forming the image on a plurality of pages. Although the period between the papers (hereinafter referred to as an inter-paper period) varies depending on the specification of the image forming apparatus 1, the inter-paper period is generally set to about 500 ms. It is noted that an ordinary image forming operation (i.e., an exposure operation of the exposure device 13 to the photosensitive member 8) is not performed in the inter-paper period.

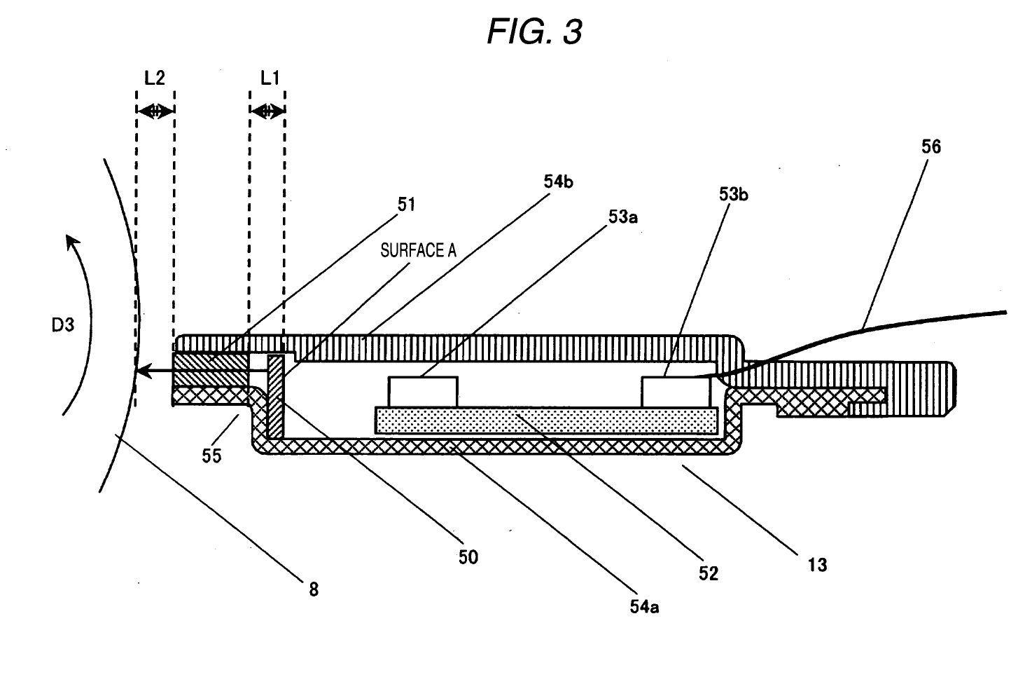

FIG. 3 is a diagram showing a configuration of the exposure device 13 of the image forming apparatus 1 according to the embodiment of the invention. Hereinafter, the configuration of the exposure device 13 will be described with reference to FIG. 3. In FIG. 3, reference numeral 50 denotes an achromatic transparent glass substrate. In the embodiment, the glass substrate 50 is made of a borosilicate glass that is advantageous in cost. However, when there is a need to more efficiently radiate heat generated from the light emitting elements, a control circuit, a driving circuit, or the like, those circuits being formed of thin-film transistors on the glass substrate 50, the glass substrate 50 may be made of glass or quartz containing heat conductivity additive materials such as MgO, Al₂O₃, CaO, and ZnO.

On a plane A of the glass substrate 50, the organic EL elements as the light emitting elements are formed in a direction (a main scanning direction) perpendicular to the drawing with a resolution of 600 dpi (dots per inch). Reference numeral 51 denotes a lens array constituted by aligning rod shaped lenses made of plastic or glass in an array configuration. The lens array 51 introduces the output light beams from the organic EL elements formed on the plane A onto the surface of the photosensitive member 8 as an erected image of same magnification. The positional relation between the glass substrate 50, the lens array 51, and the photosensitive member 8 is adjusted such that one focal point of the lens array 51 is placed on the plane A of the glass substrate 50 and the other focal point of the lens array 51 is placed on the surface of the photosensitive member 8. That is, the distance L1 between the plane A and a plane closest to the lens array 51 and the distance L2 between a plane of the lens array 51 and the surface of the photosensitive member 8 are equal to each other, i.e., a relation of L1=L2.

Reference numeral 52 denotes a relay substrate having an electronic circuit formed on a glass epoxy substrate, for example. Reference numerals 53a and 53b denote a connector A and a connector B, respectively. At least the connector A 53a and the connector B 53b are mounted on the relay substrate 52. The relay substrate 52 relays the image data, the light intensity correction data and other control signals supplied through a cable 56 such as flexible flat cables from external source to the exposure device 13 through the connector B 53b and then transmits the signals to the glass substrate 50.

Since it is difficult to directly mount the connectors on the surface of the glass substrate 50 considering the bonding strength and reliability in various environment, in the embodiment, it is constructed in a manner that an FPC (flexible printed circuit) is used as a connecting unit for connecting the connector A 53a of the relay substrate 52 and the glass substrate 50 to each other and the substrate 50 and the FPC are bonded with an ACF (anisotropic conductive film), for example, thereby connecting the FPC directly onto an ITO (indium tin oxide) electrode, for example formed in advance on the glass substrate 50.

The connector B 53b is a connector for connecting the exposure device 13 to an external source. Generally, the ACF connection may cause a problem of bonding strength. However, by providing the connector B 53b for the connection of the exposure device 13 on the relay substrate 52, it is possible to secure sufficient strength on an interface to which a user directly makes an access.

Reference numeral 54a denotes a housing A molded by bending a metal plate, for example. An L-shaped portion 55 is formed on a side of the housing A 54a facing the photosensitive member 8, and the glass substrate 50 and the lens array 51 extend along the L-shaped portion 55. When it is constructed in a manner that an end face of the housing A 54a to the side of the photosensitive member 8 and an end face of the lens array 51 are positioned in the same plane and one end portion of the glass substrate 50 is supported by the housing A 54a, thereby securing molding precision of the L-shaped portion 55, it is possible to adjust the positional relation between the glass substrate 50 and the lens array 51 with high precision. Since the housing A 54a requires high dimensional precision, the housing A 54a is preferably made of metal. By making the housing A 54a from metal, it is possible to suppress the influence of noise to the electronic components such as the control circuit formed on the glass substrate 50 and IC chips mounted on the surface of the glass substrate 50.

Reference numeral 54b denotes a housing B by molding resins. A cutout portion (not shown) is formed on a portion of the housing B 54b in the vicinity of the connector B 53b. A user can access the connector B 53b through the cutout portion. The image data, the light intensity correction data, the control signals such as the clock signals and the line sync signals, the driving power of the control circuit, the driving power of the organic EL elements serving as the light emitting elements are supplied to the exposure device 13 from the above mentioned controller 41 (see FIG. 1 for reference) through the cable 56 connected to the connector B 53b.

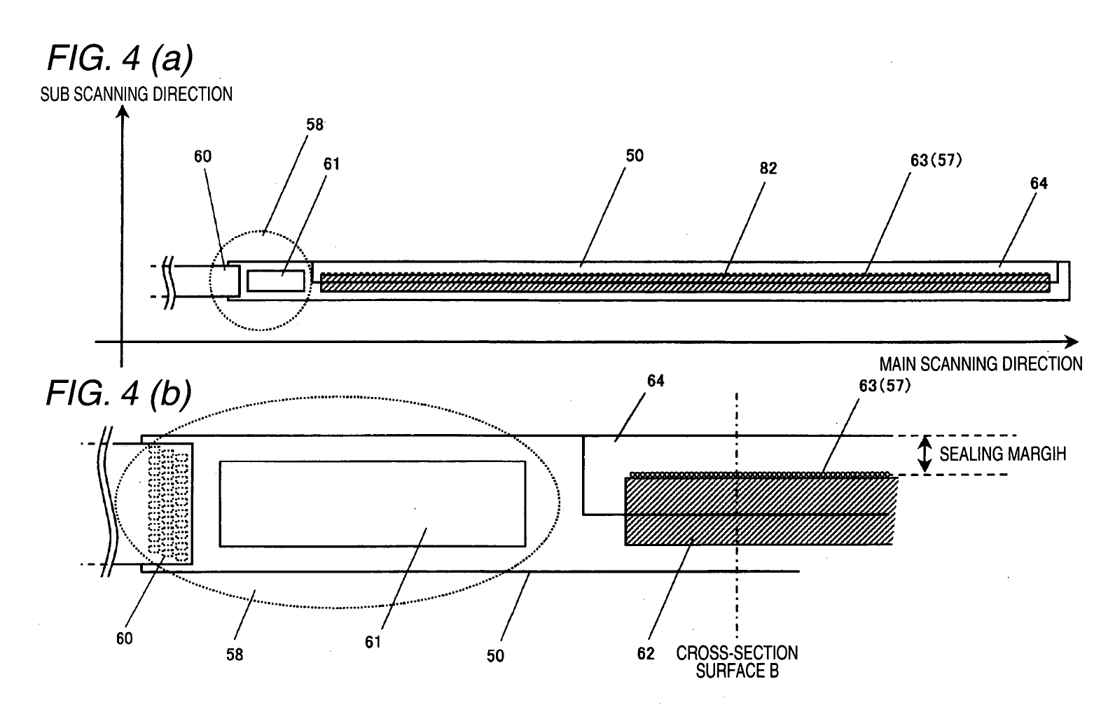

FIG. 4A is a top view of the glass substrate 50 related to the exposure device 13 of the image forming apparatus 1 according to the embodiment of the invention, and FIG. 4B is an enlarged view of a main part thereof. Hereinafter, the arrangement of the glass substrate 50 according to the embodiment of the invention will be described with reference to FIGS. 3 and 4.

In FIG. 4, the glass substrate 50 is a rectangular substrate with longitudinal and transversal sides and having a thickness of about 0.7 mm and a plurality of organic EL elements as the light emitting elements are aligned in an array configuration along a direction of the longitudinal side (a main scanning direction). In the embodiment, the organic EL elements 63 required for exposing at least A4 size paper (210 mm) are disposed in the longitudinal direction of the glass substrate 50, and the length of the longitudinal side of the glass substrate 50 is set to 250 mm including a layout space for a drive control unit 58 to be described later. Although in the embodiment, the glass substrate 50 having a rectangular shape is described to simplify the description, a modification may be applied to the glass substrate 50 in which a cutout portion for the positioning of the glass substrate 50 fitted to the housing A 54a is provided on a portion of the glass substrate 50.

Reference numeral 58 denotes a drive control unit which receives the binary image data, the light intensity correction data, and the control signals such as the clock signals and the line sync signals, supplied from an external source. The drive control unit 58 includes an interface unit for receiving those signals from sources external to the glass substrate 50 and an IC chip (a source driver 61) for controlling the driving of the organic EL elements 63 on the basis of the received signals.

Reference numeral 60 denotes an FPC (flexible print circuit) as the interface unit for connecting the connector A 53a of the relay substrate 52 and the glass substrate 50 to each other. The FPC 60 is directly connected to a circuit pattern (not shown) provided on the glass substrate 50 without being connected through the connectors or the like. As described above, the binary image data, the light intensity correction data, the control signals such as the clock signals and the line sync signals, the driving power of the control circuit, and the driving power of the organic EL elements 63 serving as the light emitting elements, supplied to the exposure device 13 from an external source are relayed to the relay substrate 52 shown in FIG. 3, and then supplied to the glass substrate 50 through the FPC 60.

Reference numeral 63 denotes organic EL elements serving as an exposure light source of the exposure device 13. In the embodiment, a number (5120) of organic EL elements 63 are aligned in an array configuration in the main scanning direction with a resolution of 600 dpi, and the lighting and non-lighting of the individual organic EL element 63 is individually controlled by a TFT circuit to be described later.

Reference numeral 61 denotes a source driver supplied as an IC chip which controls the driving of the organic EL elements 63 and is flip-chip mounted on the glass substrate 50. A bare chip component is used as the source driver 61 considering a surface mounting on the glass. The source driver 61 is supplied with power, the control-related signals such as the clock signals and the line sync signals, and 8-bit light intensity correction data from a source external to the exposure device 13 through the FPC. The source driver 61 serves as a driving current setting unit of the organic EL elements 63. Specifically, on the basis of the light intensity correction data generated from the controller CPU (not shown) installed in the controller 41 (see FIG. 1 for reference) the source driver 61 serving as the light intensity correcting unit and the light intensity setting unit of the organic EL elements 63 sets the driving current for driving the individual organic EL elements 63. The operation of the source driver 61 based on the light intensity correction data will be described later in detail.

In the glass substrate 50, the source driver 61 is connected to the bonding portion of the FPC 60 through a circuit pattern (not shown) made of an ITO formed with a metal on the surface, for example. The light intensity correction data and the control signals such as the clock signals and the line sync signals are input to the source driver 61 as the driving current setting unit through the FPC 60. In this way, the FPC 60 serving as the interface unit and the source driver 61 serving as the driving parameter setting unit constitute the drive control unit 58.

Reference numeral 62 denotes a TFT circuit formed on the glass substrate 50. The TFT circuit 50 includes a gate controller (not shown) for controlling the lighting and non-lighting timing of the organic EL elements 63, such as shift registers and data latch units, a driving circuit (not shown) (hereinafter referred to as a pixel circuit) for supplying driving current to the individual organic EL elements 63, and a switching circuit (as selection signal generation circuit 140) for turning on and off a light intensity sensor 57 to be described later. The pixel circuits are provided to each of the organic EL elements 63 and are disposed in parallel with the light emitting element array formed by the organic EL elements 63. The values of the driving current for driving the individual organic EL elements 63 are set to the pixel circuit by the source driver 61 serving as the driving parameter setting unit.

The gate controller (not shown) constituting the TFT circuit 62 is supplied with power, the control signal such as the clock signals and the line sync signals, and the binary image data, from a source external to the exposure device 13 through the FPC 60, and controls the lighting and non-lighting of the individual light emitting elements on the basis of the power and the signals. The operations of the gate controller (not shown) and the pixel circuit (not shown) will be described later in detail. Moreover, the configuration of sensors in the TFT circuit 62 will be described later in detail.

Reference numeral 64 denotes a sealed glass. Since the light emitting characteristic of the organic EL elements 63 deteriorates drastically due to the influence of moisture such as shrinking of the light emitting area with time and generation of non-lighting portions (dark spot) in the light emitting area, it is necessary to seal the organic EL elements 63 for blocking the moisture. In the embodiment, since a beta sealing method in which the sealed glass 64 is attached to the glass substrate 50 using an adhesive agent and the sealing area is generally separated by 2000 μm in the sub-scanning direction from the light emitting element array constituted by the organic EL elements, a sealing margin of 2000 μm is secured in the embodiment.

Reference numeral 57 denotes a light intensity sensor formed on a top surface of the organic EL elements 63 shown in FIG. 4B. The light intensity of the individual organic EL elements 63 is measured by the light intensity sensor 57. As a rule, it is necessary to measure the light intensity of each of the organic EL elements 63 by individually lighting the organic EL elements one by one. However, since the light intensity sensor 57 is sufficiently separated from the organic EL elements 63 serving as an object to be measured, the light intensity sensor 57 is rarely influenced by the individual lighting (i.e., the output light from the organic EL elements 63 is attenuated). Therefore, in the embodiment, by providing a plurality of light intensity sensors 57, it is possible to measure the light intensity of a plurality of organic EL elements 63 at the same time.

In the embodiment, the organic EL elements 63, the TFT circuit 62, and the light intensity sensor 57 are integrated as a monolithic device made of poly-silicon. That is, since the light transmittance of low-temperature poly-silicon constituting the TFT circuit 62 is relatively high, it is possible to bury the light intensity sensor 57 corresponding to the individual organic EL elements 63 at a portion adjacent to the TFT circuit 62 even in a so-called bottom emission type organic EL element in which the exposure light is extracted from the glass substrate 50 side. In this case, the light intensity sensor is generally formed on the entire surface immediately below the light emitting plane of the organic EL elements 63, but may be formed at a portion of the surface corresponding to the location of the organic EL elements 63.

The outputs of the plurality of the light intensity sensors 57 are input to the above-mentioned source driver 61 through wires (not shown). The outputs of the light intensity sensors (light intensity sensor output) are converted to a voltage value by the source driver 61 using a charge accumulation method, amplified with a predetermined amplification factor, and then subjected to an analog-to-digital conversion. The digital data (hereinafter referred to as light intensity-measurement data) is output to a destination external to the exposure device 33 through the FPC 60, the relay substrate 52, and the cable 56, which are depicted in FIG. 3. As will be described later in detail, the light intensity measurement data is received and processed by the controller CPU (not shown) installed in the controller 41 (not shown), thereby outputting 8-bit light intensity correction data.

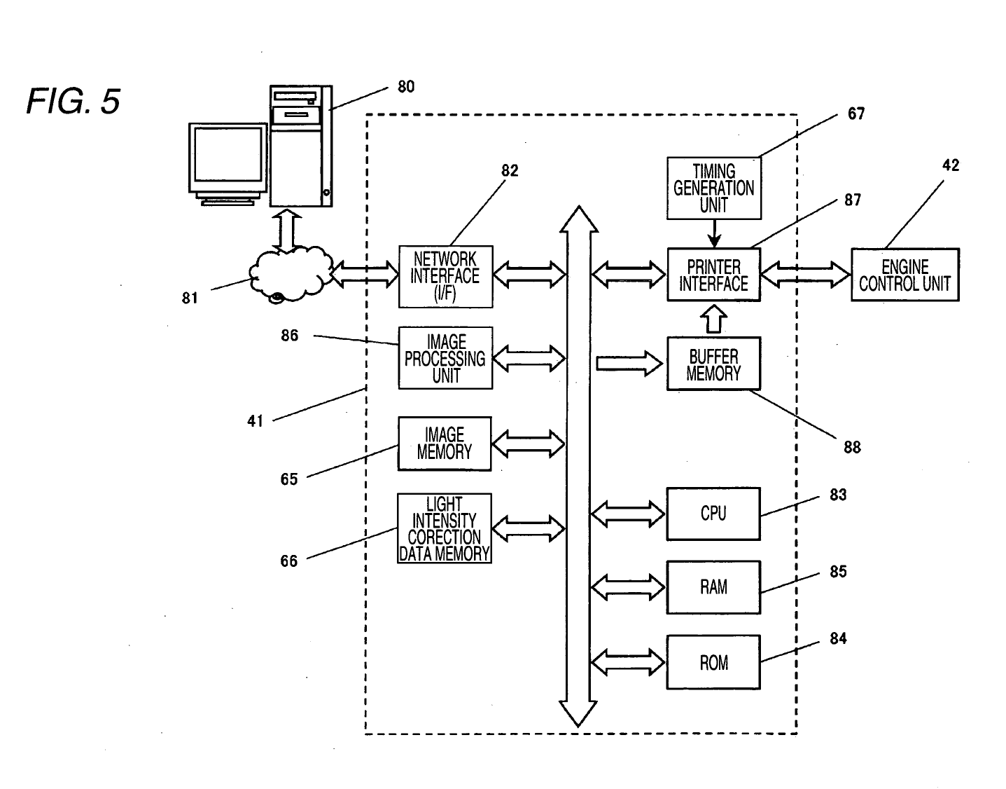

FIG. 5 is a block diagram showing a configuration of the controller 41 of the image forming apparatus 1 according to the embodiment of the invention. Hereinafter, the operation of the controller and the light intensity correction will be described with reference to FIG. 5.

Reference numeral 80 in FIG. 5 denotes a computer. The computer 80 is connected to a network 81 through which image information and print job information such as the number of printing pages and printing modes (for example, color or monochrome) are transmitted to the controller 41. Reference numeral 82 denotes a network interface through which the controller 41 receives the image information or the print job information so as to expand the image information into a printable binary image data. Moreover, the controller 41 transmits error information detected by the image forming apparatus as so-called status information to the computer 80 through the network 81.

Reference numeral 83 denotes a controller CPU which controls the operation of the controller 80 in accordance with a program stored in an ROM 84. Reference numeral 85 denotes an RAM which is used as a work area of the controller CPU 83 and in which the image information, the print job information, or the like received through the network interface 82 are temporarily stored.

Reference numeral 86 denotes an image processing unit in which an image processing operation (for example, an image expanding process based on a printer language, a color correction, an edge correction, a screen generation or the like) is performed in units of a page on the basis of the image information and the print job information transmitted from the computer 80 and the printable binary image data is generated. Then, the generated binary image data is stored in the image memory 65 in units of a page.

Reference numeral 66 denotes a light intensity correction data memory constituted by a rewritable nonvolatile memory such as an EEPROM.

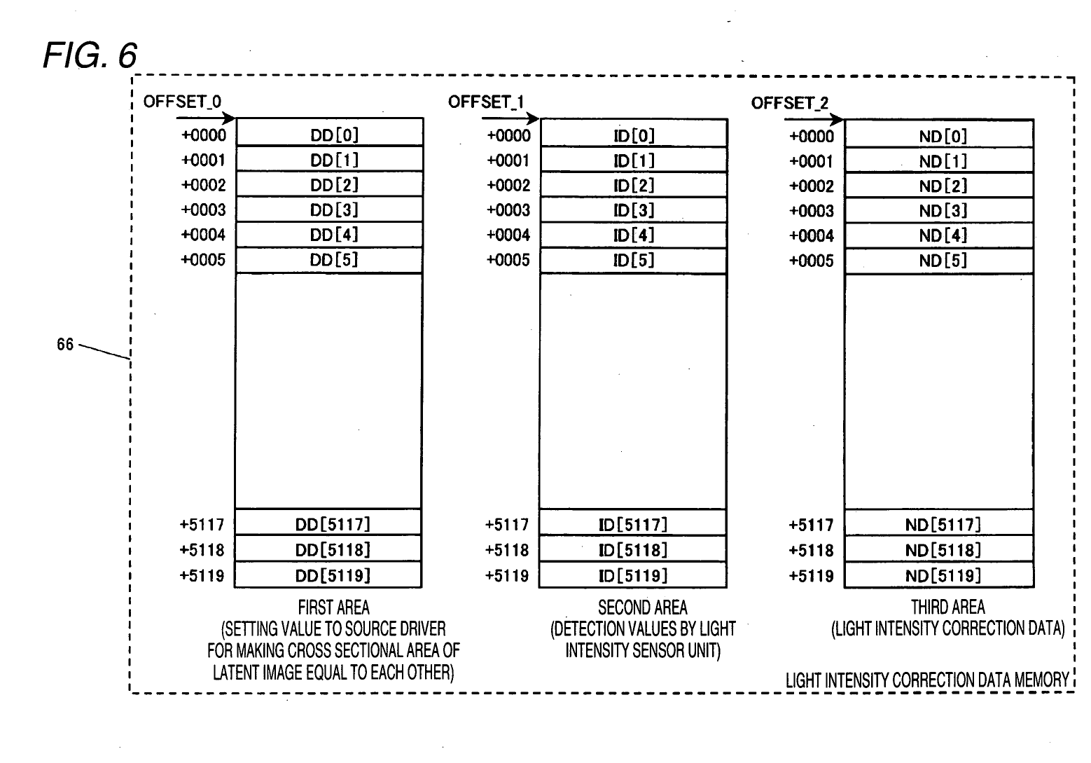

FIG. 6 is an explanatory diagram showing a content of a light intensity data memory of the image forming apparatus 1 according to the embodiment of the invention.

Next, the structure and content of data stored in the light intensity correction data memory will be described with reference to FIG. 6.

As shown in FIG. 6, the light intensity-correction data memory 66 has three areas, i.e., including first to third areas. Each area includes a number (5120) of 8-bit data corresponding the number of the organic EL elements 63 (see FIG. 4 for reference) constituting the exposure device 13 (see FIG. 3 for reference) and occupies a total of 15360 bytes.

First, data DD[0] to DD[5119] stored in the first area will be described with reference to FIGS. 3, 4 and 6.

The manufacturing process of the above-mentioned exposure device 13 (see FIG. 3 for reference) includes a process of adjusting the light intensity of the individual organic EL elements 63 (see FIG. 4 for reference) constituting the exposure device 13. In this case, the exposure device 13 is fitted to a certain jig (not shown), and the lighting and non-lighting of the organic EL elements 63 is individually controlled on the basis of the control signals supplied from a source external to the exposure device 13.

Two-dimensional light intensity distribution of the individual organic EL elements 63 is measured at an image forming plane of the photosensitive member 8 (see FIG. 3 for reference) by a CCD camera provided in the jig (not shown). The jig (not shown) calculates the electric potential distribution of the latent image formed on the photosensitive member 8 on the basis of the light intensity distribution and calculates the cross sectional area of the latent image having high correlation with the toner adhering amount on the basis of the actual development condition (the development bias value). The jig (not shown) changes the driving current value for driving the organic EL elements 63 (as described above, the current value for driving the organic EL elements 63 can be set by programming an analog value to the pixel circuit constituting the TFT circuit 62 (see FIG. 4 for reference) using the source driver 61 (see FIG. 4 for reference)) so as to extract the driving current value, i.e., a setting value to the pixel circuit, such that each of the cross sectional areas of the latent images formed by the individual organic EL elements 63 become substantially the same.

When assuming that both the light emitting areas of the organic EL elements 63 and the light intensity distributions in the light emitting plane are equal to each other and the measurement were performed at a general development condition, the cross sectional area of the latent image is almost proportional to the exposure light intensity. In addition, since “the light intensity at a constant exposure time period” and “the exposure light intensity” have the same meaning and the light intensity of the organic EL elements 63 is generally proportional to the driving current value (i.e., the setting value to the pixel circuit), it may be possible to obtain the setting value to the pixel circuit (i.e., the setting data to the source driver 61), making each of the cross sectional areas of the latent images formed by the individual organic EL elements 63 to be equal to each other by a single measurement of the cross sectional area of the individual organic EL elements 63 in a state that the driving current to the entire pixel circuit is set to the same value.

The setting data to the source driver 61 thus obtained is stored in the first area of the light intensity correction data memory 66. As described above, the number of the setting data is 5120 equal to the number of the organic EL elements 63 constituting the exposure device 13 (i.e., equal to the number of the pixel circuits). In this way, “the setting value to the source driver 61 making each of the cross sectional areas of the latent images formed by the individual organic EL elements to be equal to each other in the initial state” is stored in the first area of the light intensity correction data memory 66.

Next, the data ID[0] to ID[5119] stored in the second area will be described with reference to FIGS. 3, 4, and 6.

The jig acquires not only the data stored in the first area, but also acquires the 8-bit light intensity measurement data based on the output of the light intensity sensor 57 (see FIG. 4 for reference) through the source driver 61 (see FIG. 4 for reference) of the exposure device 13. Accordingly, it is possible to acquire “the light intensity measurement data when each of the cross sectional areas of the latent images formed by the individual organic EL elements is made equal to each other in the initial state.” The 8-bit light intensity measurement data ID[n] is stored in the second area.

Here, it is necessary that the driving condition of the organic EL elements 63 when the light intensity measurement data ID[n] is acquired by the jig is equal to that of at the time of measuring the light intensity. Therefore, in the embodiment, a total of about 30 ms of the lighting and non-lighting period is provided by applying multiple times of 350 μs period corresponding to 1 line period (a raster period) of the image forming apparatus 1.

In this way, in the manufacturing process of the exposure device 13, the data stored in the first and second areas is acquired, and the data is written to the light intensity correction data memory 66 from the jig through an electric communication unit (not shown).

Next, the data ND[0] to ND[5119] stored in the third area will be described with reference to FIGS. 3, 4, 5, and 6.

The image forming apparatus 1 related to the embodiment of the invention includes a light intensity correction unit (a light intensity correcting unit or the controller CPU 83 (see FIG. 5 for reference)) correcting the light intensity of the organic EL elements 63 to be equal to each other on the basis of the measurement result of the light intensity sensor 57 serving as the light intensity measuring unit, in which the light intensity setting unit (or the controller CPU 83) sets the light intensity of each of the organic EL elements 63 at the time of forming the image on the basis of the output of the light intensity correction unit. The light intensity setting value (i.e., light intensity correction data) of each of the organic EL elements 63 when the image is formed by the controller CPU 83 serving as the light intensity correction unit is stored in the third area.

As described above, in the image forming apparatus 1 of the embodiment, the light intensity of the organic EL elements 63 constituting the exposure device 13 is measured at a predetermined timing to be described later, such as in the initialization period of the image forming apparatus 1, in a start-up period of the image forming operation, in the inter-paper period, and at the time of completing the image forming operation. The controller CPU 83 generates the light intensity correction data on the basis of the light intensity measurement data measured at these timings, “the setting value to the source driver 61 making each of the cross sectional areas of the latent images formed by the individual organic EL elements to be equal to each other in the initial state” stored in the first area in the manufacturing process of the exposure device 13, and similarly “the light intensity measurement data when each of the cross sectional areas of the latent images formed by the individual organic EL elements is made equal to each other in the initial state” stored in the second area in the manufacturing process of the exposure device 13. That is, the controller CPU 83 functions as the light intensity correcting unit for correcting the light intensity of the organic EL elements 63 with reference to the light intensity of the organic EL elements 63 detected by the light intensity sensor 57.

Hereinafter, the details of computation of the light intensity correction data by the controller CPU 83 will be described, in which it is considered that the light intensity at the time of measuring the light intensity is made equal to that of at the time of forming the image in order to clarify the point of the invention.

Assuming that “the setting value to the source driver 61 making each of the cross sectional areas of the latent images formed by the individual organic EL elements to be equal to each other in the initial state” stored in the first area is DD[n] (wherein, n represent an organic EL element number in the main scanning direction), “the light intensity measurement data when each of the cross sectional areas of the latent images formed by the individual organic EL elements is made equal to each other in the initial state” stored in the second area is ID[n], and a new light intensity measurement data measured in the initialization operation or the like is PD[n], a new light intensity correction data ND[n] to be written in the third area can be measured by the controller CPU 83 on the basis of Equation 1. Here, the light intensity measurement data ID[n] corresponds to the measured light intensity of the organic EL elements, and the light intensity correction data ND[n] corresponds to the electric current value flowing through the individual elements, which is set by the source driver 61.
ND[n]=DD[n]×ID[n]/PD[n] [Equation 1]

(n represents an organic EL element number in the main scanning direction)

In this way, the generated light intensity correction data ND[n] is written to the third area of the light intensity correction data memory 66 (see FIG. 5 for reference). Thereafter, the light intensity correction data ND[n] is copied from the light intensity correction data memory 66 to a predetermined area of the image memory 65 (see FIG. 5 for reference) prior to the image forming operation. In the image forming operation, the light intensity correction data ND[n] copied to the image memory 65 is temporarily stored in a buffer memory 88 (see FIG. 5 for reference) to be described later together with the binary image data and then output to the engine control unit 43 (see FIG. 5 for reference) through a printer interface 87 (see FIG. 5 for reference).

The light intensity measurement data is converted to a voltage value by the source driver 61 using a charge accumulation method. Although the charge accumulation method is effective in improving an SN ratio, the charge accumulation requires some extent of accumulation time period since the magnitude of the output (electric current value) of the light intensity sensor 57 (see FIG. 4 for reference) is very small, which will be described later.

Next, the description will be continued with reference to FIG. 5.

Reference numeral 88 denotes a buffer memory in which the binary image data stored in the image memory 65 and the above-mentioned light intensity correction data is stored before being transmitted to the engine control unit 42. The buffer memory 88 is composed of a so-called dual port RAM in order to absorb the difference between the transmission speed from the image memory 65 to the buffer memory 88 and the data transmission speed from the buffer memory 88 to the engine control unit 42.

Reference numeral 87 denotes a printer interface through which the binary image data stored to the image memory 65 in units of a page and the light intensity correction data are transmitted to the engine control unit 42 in synchronism with the clock signals and the line sync signals generated by the timing generation unit 67.

FIG. 7 is a block diagram showing a configuration of the engine control unit 42 of the image forming apparatus 1 according to the embodiment of the invention. Hereinafter, the operation of the engine control unit 42 will be described with reference to FIGS. 1 and 7.

In FIG. 7, reference numeral 90 denotes a controller interface to which the light intensity correction data and the binary image data in units of a page are transmitted from the controller 41.

Reference numeral 91 denotes an engine control CPU which controls the image forming operation of the image forming apparatus 1 on the basis of the program store in the ROM 92. Reference numeral 93 denotes an RAM which is used as a work area at the time of operating the engine control CPU 91. Reference numeral 94 denotes a rewritable nonvolatile memory such as an EEPROM. Information related to lifetime of components such as the rotation time period of the photosensitive member 8 of the image forming apparatus 1 and the operation time period of the fixing unit 23 (see FIG. 1 for reference) is stored in the nonvolatile memory 94.

Reference numeral 95 denotes a serial interface. Information received from a sensor group such as the recording paper pass detection sensor 21 (see FIG. 1 for reference) and the recording paper rear-end detection sensor 28 (see FIG. 1 for reference) or the output of the power source monitor unit 44 (see FIG. 1 for reference) is converted to a serial signal having a predetermined period by a serial conversion unit (not shown) and then transmitted to the serial interface 95. The serial signal received by the serial interface 95 is converted to a parallel signal and then read to the engine control CPU 91 through a bus 99.

Meanwhile, control-related signals such as start-up and stop signals to the paper feeding roller 18 (see FIG. 1 for reference) and the driving source 38 (see FIG. 1 for references), control signals to an actuator group 96 such as the electromagnetic clutch (not shown) controlling the transmission of driving force to the feeding roller 18 (see FIG. 1 for reference), and control signals to a high voltage source control unit 97 managing the electric potential settings of such as the development bias, the transfer bias, and the charging potential are transmitted to the serial interface 95 as a parallel signal. In the serial interface 95, the parallel signal is converted to a serial signal and transmitted to the actuator group 96 and the high voltage source control unit 97. In this way, in the embodiment, the sensor input signals and the actuator control signals which are not required to be detected at high speed are output through the serial interface 95. Meanwhile, the control signals for driving and stopping the registration roller 19 requiring some extent of high speed operation are directly connected to an output terminal of the engine control CPU 42.

Reference numeral 98 denotes an operation panel connected to the serial interface 95. A user command input to the operation panel 98 is recognized by the engine control CPU 91 through the serial interface 95. Alternatively, the operation panel serving as a command input unit allowing a user to input a command may be provided in the embodiment, so that the light intensity of the organic §L elements 63 constituting the exposure device 13 is measured and corrected on the basis of the input to the operation panel.

The command may be input from an external computer or the like through the controller 41. As a specific example, a case may be considered in which a large amount of printing has been performed, the user has found an uneven printing density distribution on the printed paper, and the user forcibly correct the light intensity, thereby securing the image quality. When the image forming apparatus 1 is in a standby mode, the user can instruct to forcibly perform the light intensity correcting operation at any time. Even in the image forming operation, the user can instruct to perform the light intensity correcting operation by putting the image forming apparatus 1 into an off-line mode so as to temporarily holding the image forming operation.

In the end, when a request for correcting the light intensity is input from the operation panel 98 serving as the command input unit or the like, as described above in <Initialization Operation>, the engine control CPU 91 starts driving of components of the image forming apparatus 1 and outputs a creation request of dummy image information for the light intensity correction to the controller 41. Then, the controller CPU 83 installed in the controller 41 generates the dummy image information for the light intensity correction in accordance with the creation request, and the organic EL elements constituting the exposure device 13 is controlled to be lighted or unlighted on the basis of the dummy image information for the light intensity correction. In this case, the light intensity of the individual organic EL elements 63 is detected by the light intensity sensor 57 provided to the exposure device 13, and the light intensity correcting operation is performed on the basis of the light intensity detection result such that the light intensity of the individual organic EL elements 63 becomes equal to each other.

Next, the operation of measuring the light intensity of the organic EL elements 63 will be described with reference to FIGS. 1, 5, 6, and 7.

As described later, although the light intensity correcting operation is performed at various timings such as in the initialization period immediately after the start-up of the image forming apparatus 1, prior to the start of printing operation, in the inter-paper period, after the start of the printing operation, and at a user designation timing through the operation panel 98, description will be made only to a case where the light intensity measurement operation is performed at the time of initializing the image forming apparatus 1. Moreover, although the image forming apparatus 1 of the embodiment is configured to be able to form a full-color image and has four exposure devices 13Y to 13 K (see FIG. 1 for reference) corresponding to four colors, description will be made only to the operation regarding only one color and the exposure devices will be denoted by the exposure device 13. Moreover, in the following situation, it is assumed that the driving source 38 (see FIG. 1 for reference) and the development station 2 (see FIG. 2 for reference) are already in an activated state as described above in detail in <Initialization Operation>.

In the image forming apparatus 1, since the image forming operation is managed by the engine control unit 42, the light intensity correction operation is activated by the engine control CPU 91 of the engine control unit 42. First, the engine control CPU 91 outputs a creation request of dummy image information different from normal binary image data related to the image formation to the controller 41.

The engine control unit 42 and the controller 41 are connected to each other through a bidirectional serial interface (not shown), and a request command and an acknowledge signal to the request command (response information) are communicated to each other. The creation request of the dummy image information issued by the engine control, CPU 91 is output to the controller 41 from the controller interface 90 through the bus 99 using the bidirectional serial interface (not shown).

The controller CPU 83 installed in the controller 41 creates the dummy image information, i.e., the binary image data used in measuring the light intensity and write the information to the image memory 65. The controller CPU 83 reads out “the setting value to the source driver 61 making each of the cross sectional areas of the latent images formed by the individual organic EL elements 63 to be equal to each other in the initial state” DD[n] (n: 0 to 5119) stored in the first area (see FIG. 6 for reference) of the light intensity correction data memory 66 and writes the value to a predetermined area of the image memory 65. After completing these processes, the controller CPU 83 outputs response information to the engine control unit 42 through the printer interface 87.

In this case, the engine control CPU 91 of the engine control unit 42 having received the above-mentioned response information immediately sets a writing timing to the exposure device 13. That is, the engine control CPU 91 sets a writing timing for the exposure device 13 to form the electrostatic latent image to timers as hardware (not shown) and immediately starts the operation of the timer when receiving the response information. This function is provided to determine the start timings of the plurality of exposure devices 13 corresponding to each color. Such a strict timing setting may not be required in the light intensity measuring operation and zero value (0) may be set to each of the timers, for example. The timer outputs an image data transmission request to the controller 41 after a predetermined time period. The controller 41 having received the image data transmission request transmits the binary image data to the exposure device 13 through the controller interface 90 in synchronization with the timing signals (clock signals, line sync signals, or the like) generated from the timing generation unit 67. At the same time, the light intensity setting value written to the image memory 65 is transmitted to the exposure device 13 in synchronization with the above-mentioned timing signals.

In this way, the binary image data transmitted in synchronization with the timing signals is input to the TFT circuit 62 of the exposure device 13, and the light intensity setting value is input to the source driver 61 of the exposure device 13. In the exposure device 13, the lighting and non-lighting of the corresponding organic EL element 63 is controlled on the basis of the binary image data, i.e., ON/OFF information. The light intensity of the individual organic EL elements 63 at that moment is measured by the light intensity sensor 57.

In this way, the lighting and non-lighting of the organic EL elements 63 is controlled and the light intensity is measured by the light intensity sensor 57. The output (analog current value) of the light intensity sensor 57 is converted to a voltage value by the source driver 61 using the charge accumulation method, amplified with a predetermined amplification factor, and then subjected to an analog-to-digital conversion. Thereafter, the data is output from the source driver 61 as an 8-bit light intensity measurement data (digital data).

The light intensity measurement data output from the source driver 61 is transmitted to the controller 41 from the engine control unit 42 through the controller interface 90, and received by the controller CPU 83 of the controller 41.

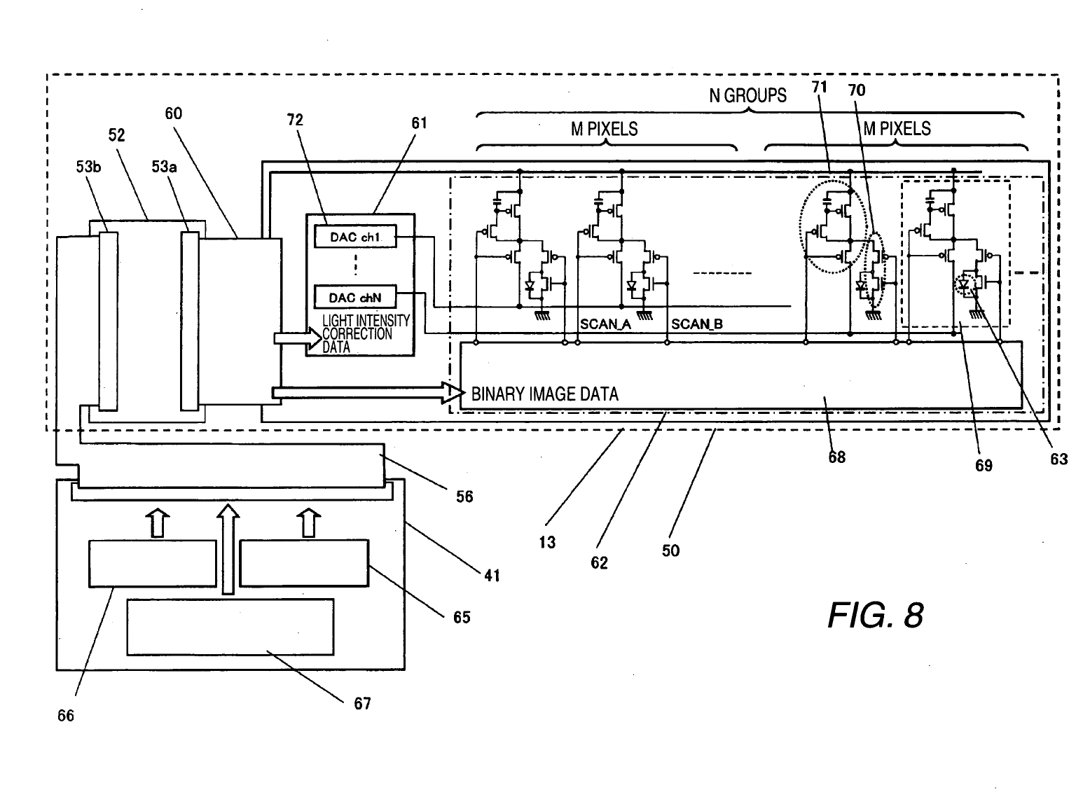

FIG. 8 is a circuit diagram showing the exposure device 13 of the image forming apparatus 1 according to the embodiment of the invention. Hereinafter, the TFT circuit 62 and the lighting and non-lighting control of the source driver 61 will be described with reference to FIG. 8.

The TFT circuit 62 is mainly divided into the pixel circuit 69 and the gate controller 68. The pixel circuit 69 is provided to each of the organic EL elements 63, and N groups of the organic EL elements 63 corresponding to M pixels are arranged on the glass substrate 50.

In the embodiment, a number of organic EL elements 63 corresponding to 8 pixels are provided in one group (i.e., M=8) and the number of groups is 640. Accordingly, the total number of pixels is 5120 (8×640=5120). Each of the pixel circuits 69 includes a driver unit 70 supplying an electric current to the organic EL elements 63 so as to drive the organic EL elements 63 and a so-called electric current programming unit 71 for storing the current value (i.e., the driving current value of the organic EL elements 63) supplied from drivers for controlling the lighting and non-lighting of the organic EL elements 63 to a capacitor included therein. The pixel circuit 69 can drive the organic EL elements 63 with a constant current in accordance with the driving current value programmed at a predetermined timing.

The gate controller 68 includes a shift register (not shown) sequentially shifting the input binary image data, a latch unit (not shown) disposed in parallel with the shift register and holding a predetermined number of pixels input to the shift register in a bundle, and a control unit (not shown) controlling timings for these operations. The gate controller 68 receives the binary image data (the image information converted by the controller 41 in the case of the image forming operation or the dummy image information converted by the controller in the case of the light intensity measuring operation) from the controller 41 and outputs SCAN_A and SCAN_B signals on the basis of the binary image data, i.e., the ON/OFF information, thereby controlling timings for lighting or non-lighting the organic EL elements 63 connected to the pixel circuit 69 and timings for programming the driving current of the organic EL elements 63.

The source driver 61 includes a number of D/A converter 72 corresponding to the number N (640 in the embodiment) of groups in the organic EL elements 63. The source driver 61 sets the driving current of the individual organic EL elements 63 on the basis of the 8-bit light intensity correction data supplied through the FPC 60.

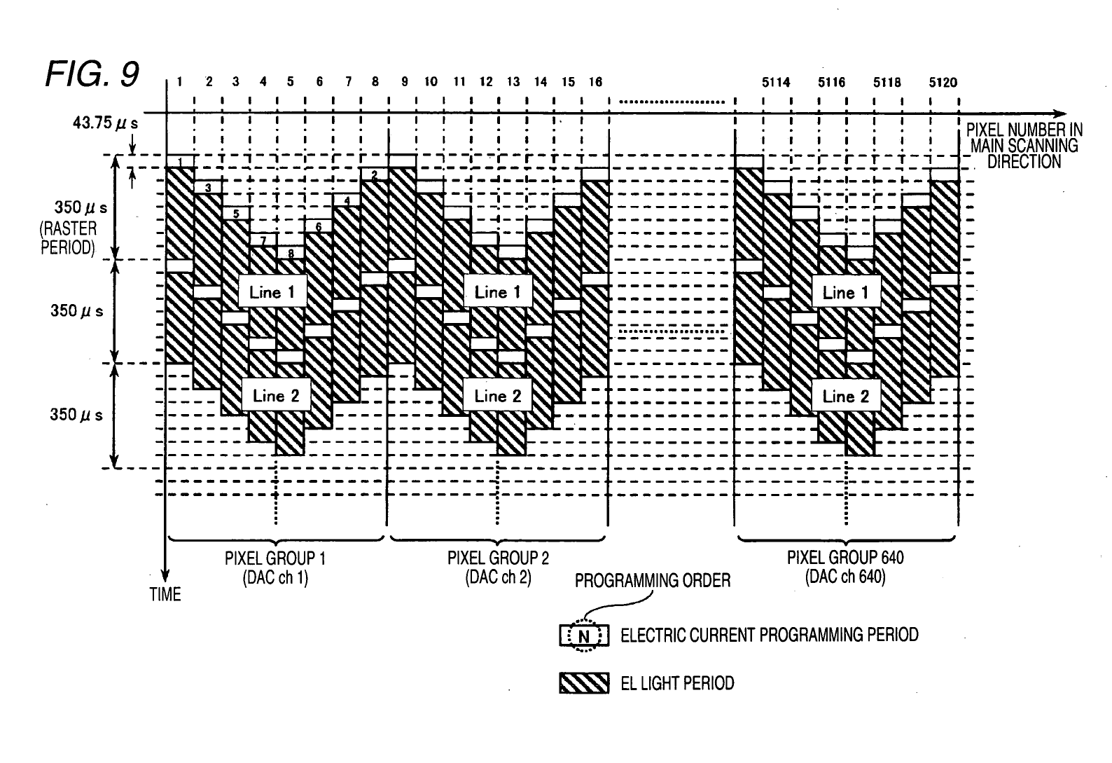

FIG. 9 is an explanatory diagram showing a current programming period related to the exposure device 13 of the image forming apparatus 1 according to the embodiment of the invention and a lighting and non-lighting period of the organic EL elements 63. Hereinafter, the lighting and non-lighting control according to the invention will be described with reference to FIGS. 8 and 9. In the following description, a single pixel group composed of 8 pixels (for example, “the pixel number in the main scanning direction” is 1 to 8 in FIG. 9) will be described in order to simplify the description.

In the embodiment, one line period (raster period) of the exposure device 13 is set to 350 μs, and ⅛ (43.77 μs) of the one line period is used as the programming period for setting the driving current value to the capacitor provided in the electric current programming unit 71.

First, the gate controller 68 (see FIG. 8 for reference) sets the SCAN_A signal and the SCAN_B signal for the number 1 pixel to ON and OFF, respectively, so as to set the programming period. In the programming period, the D/A converter 72 installed in the source driver 61 (see FIG. 8 for reference) is supplied with 8-bit light intensity correction data, and the capacitor in the current programming unit 71 (see FIG. 8 for reference) is charged by the analog level signal obtained by D/A converting the digital data. Operations in the programming period are performed regardless of ON and OFF of the binary image data input to the gate controller 68. In this way, the analog value based on the 8-bit light intensity correction data is written to the capacitor formed in the current programming unit 71 at every one line period. That is, charges accumulated in the capacitor of the current programming unit 71 is always refreshed, and thus the driving current of the organic EL elements 63 determined on the basis of the data is always maintained at a constant value.

After expiration of the programming period, the gate controller 68 (see FIG. 8 for reference) immediately switches the SCAN_A signal and the SCAN_B signal to OFF and ON states, respectively, so as to set the lighting and non-lighting period. As described above, the gate controller 68 (see FIG. 8 for reference) is already supplied with the binary image data in the image forming operation and the light intensity measuring operation, and the organic EL elements 63 is not lighted even in the lighting period when the image data is in the OFF state. Meanwhile, when the image data is in the ON state, the organic EL elements 63 are continuously lighted for the remaining time period 306.25 μs (350 μs−43.75 μs). However, since it takes a little time to switch the control signal, the lighted time period is a little decreased. As described above, in the embodiment, since it is assumed that it takes 30 ms to measure the light intensity of the organic EL elements 63, the controller 41 generates the dummy image information so that the number of lighting in the light intensity measuring operation becomes 100 (i.e., 100 lines), for example.

Meanwhile, in FIG. 9, when the programming period for the pixel circuit 69 (see FIG. 8 for reference) corresponding the number 1 pixel expires, the gate controller 68 (see FIG. 8 for reference) immediately sets the current programming period for the pixel circuit 69 (see FIG. 8 for reference) corresponding to the number 8 pixel. In a similar sequence to that of the pixel circuit corresponding to the number 1 pixel, when the programming period for the pixel circuit corresponding to the number 8 pixel expires, an operation of setting the lighting period of the organic EL elements 63 (see FIG. 8 for reference) corresponding to the pixel number is performed.

In this way, the gate controller 68 (see FIG. 8 for reference) sets the programming period and the lighting period in the order of the pixel number in the main scanning direction, i.e., “1→8→2→7→3→6→4→5→1 . . . .” By setting the lighting order in such a manner, the lighting timings of pixels disposed adjacent to each other in pixel groups adjacent to each other become close to each other in time and it is thus possible to make uneven display of image less prominent at the time of forming one line of image.

<Light Intensity Correction Operation>

Next, the configuration of the light intensity sensor 57 for acquiring the light intensity measurement data and its peripheral parts and the operation of acquiring the light intensity measurement data will be described in detail.

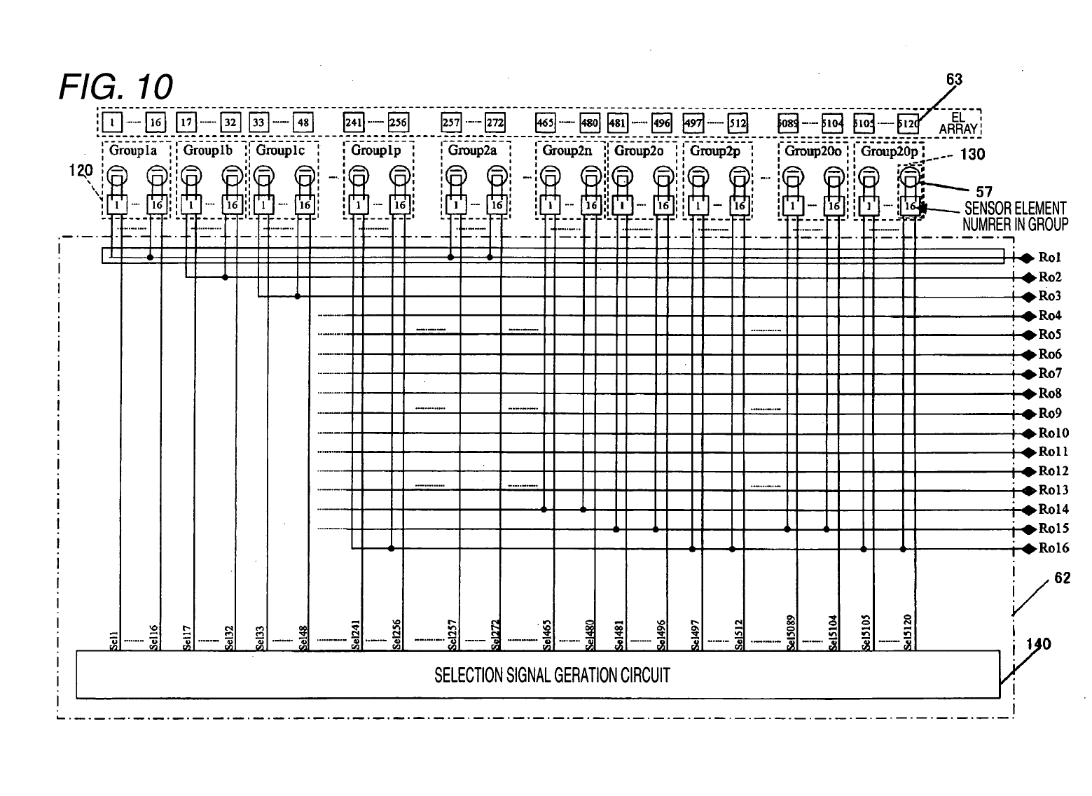

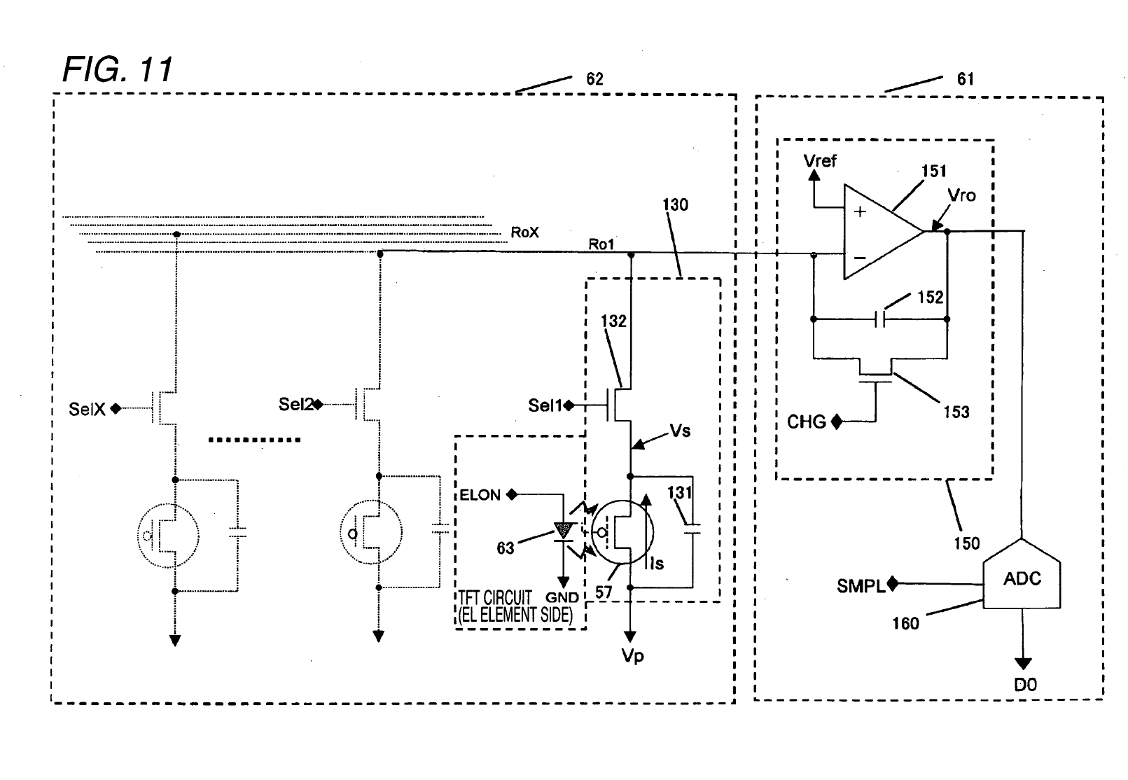

FIG. 10 shows the configurations of the organic EL elements 63, corresponding light intensity sensors 57, and the selection signal generation circuit (switching circuit) 140 switching the light intensity sensors 57. In the embodiment, as described above, a number (5120) of organic EL elements 63 are aligned in an array configuration in the main scanning direction with a resolution of 600 dpi. Moreover, a corresponding number (5120) of light intensity sensors 57 are formed at locations corresponding to the elements. Each of the light intensity sensors 57 (a sensor pixel circuit 130 including the light intensity sensor, see FIG. 11 for reference) is connected to the selection signal generation circuit 140 through selection lines SelX and to the source driver 61 through driver lines RoX (FIG. 11). The selection lines SelX and the driver lines RoX are integrally formed on the TFT circuit 62 together with the selection signal generation circuit 140.

The selection signal generation circuit 140 receives a sensor drive command from the controller 41 at a predetermined timing and outputs a sensor drive signal to a selection transistor 132 of each of the sensor pixel circuit 130. The selection signal generation circuit 140 outputs the sensor drive signal to each of the sensor pixel circuit 130 in a time sequential manner. However, it may be constructed in a manner that an output circuit constituted by general 2-stage shift registers (D-type flip-flop connection) and a single 3-input AND circuit may be allocated to each of the sensor pixel circuit. Such an arrangement is the same as that of a general selection signal generation circuit.

In the embodiment, one sensor group 120 consists of 16 light intensity sensors 57. Each of the light intensity sensors 57 in each group is assigned with a sensor element number 1 to 16. In the embodiment, the sensor groups extending in a main operation direction is categorized into 16 sensor groups, from group 1a to group 1p in the main scanning direction. Groups in each category assigned with the same alphabet notation are connected to the same driver lines RoX. For example, groups 1a, 2a, . . . , and 20a (a total of 20 groups) are connected to the driver line Ro1, and groups 1p, 2p, . . . , and 20p are connected to the driver line Ro16.

Each driver line RoX is connected to a charge amplifier 150 provided to the source driver 61 as shown in FIG. 11. That is, a total of 16 charge amplifiers 150 are provided to the source driver 61 corresponding to each of the driver lines RoX. Meanwhile, the selection signal generation circuit 140 is formed in the TFT circuit 62 like the gate controller 68 shown in FIG. 8. The selection signal generation circuit 140 (and the selection transistor 132: FIG. 11) functions as a switching circuit that inputs the sensor drive signal for driving the light intensity sensor at a predetermined timing to the sensor pixel circuit 130 through the selection line SelX. The charge amplifier 150 (and capacitor 131: FIG. 11) functions as a sensor driving circuit that actually drives the light intensity sensor. The light intensity sensor 57, the capacitor 131, and the charge amplifier 150 constitutes the light intensity measurement unit that measures the light intensity of light emitted from the organic EL elements 63.

The light intensity correcting operation is performed by the arrangement shown in FIGS. 10 and 11 at a predetermined timing to be described later. Hereinafter, the order of the output operations in each of the light intensity sensors and the operations of reading the light intensity measurement data will be described. However, the order of the reading operations is not particularly limited.

(1) First, the light intensity measurement data is read from the entire light intensity sensors in the sensor groups connected to the driver line Ro1. That is, the light intensity measurement data is read out in the order of group 1a, 2a, . . . , and 20a. In this case, the selection lines are selected in the order of Sel1, Sel2, . . . , Sel16, Sel257, Sel258, . . . , Sel4864, Sel4865, . . . , Sel4879, and Sel4880, and the sensor drive signals from the selection signal generation circuit 140 are sequentially set to ON in this order.

(2) The reading operations in (1) are performed in parallel with the entire driver lines RoX. That is, the above-mentioned reading operations are simultaneously performed through the entire driver lines Ro1 to Ro16. In this way, the light intensity measurement data corresponding to the entire sensor elements, i.e., the light intensity measurement data for the entire organic EL elements 63 are read out.

FIG. 11 is a diagram showing a connection relation between the light intensity sensor 57 and the charge amplifier 150 and an operational relation between the light intensity sensor 57 and the organic EL element 63, in which the peripheral portion of the light intensity sensor 57 is depicted in an enlarged view.

Each selection line SelX is connected the sensor pixel circuit 130 constituted by the light intensity sensor 57, the capacitor 131 connected in parallel to the light intensity sensor 57 and constituting a capacitive element, and the selection transistor 132 connected in serial to the light intensity sensor 57 and the capacitor 131. The selection transistor 132 constitutes the switching circuit of the light intensity sensor together with the selection signal generation circuit 140. The selection line SelX is connected to the selection transistor 132 which receives the sensor drive signal consisting of ON/OFF signals output from the selection signal generation circuit 140. The selection transistor 132 is turned on and off in accordance with the driving signal.

One driver line RoX is connected to a total of 20 groups of sensor group 120 (from group number 1 to 20), i.e., to a total of 320 sensor pixel circuits (16×20). Each of the driver lines RoX is connected to the charge amplifier 150 provided to the source driver 61. The charge amplifier 150 is constituted by an amplifier 151, a capacitor 152 constituting a capacitive element, and a charge/discharge selection transistor 153. In addition, the amplifier 151 of the charge amplifier 150 is connected to an ADC 160 provided in the source driver 61. The charge amplifier 150 constitutes the sensor driving circuit together with the capacitor 131 of the sensor pixel circuit 130.

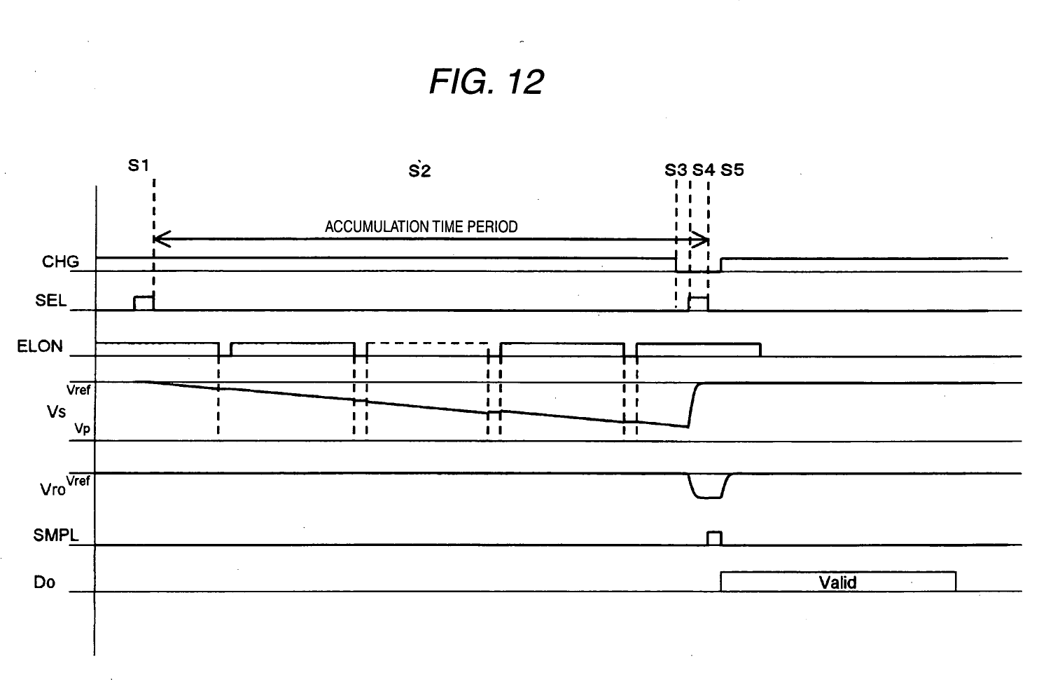

FIG. 12 is a timing chart showing operations of each part shown in FIG. 11. That is, FIG. 12 corresponds to a timing chart corresponding to the operation of reading the light intensity measurement data which is performed by each of the light intensity sensor 57 in the above-mentioned operation sequence (1). As described above, the light intensity sensor output serving as the basis of the light intensity measurement data is generated through a process in which the sensor output is converted to a voltage value by the source driver 61 using the charge accumulation method, amplified with a predetermined amplification factor, and then subjected to an analog-to-digital conversion. The following timing chart corresponds to this process.

As shown in timing charts (a) to (g) of FIG. 12, the light intensity measurement data based on the output of the light intensity sensor 57 is measured at the switching time of selection transistor 132 on the basis of the charges consumed by the capacitor 152 to compensate for stolen charges by irradiating light beams onto the light intensity sensor of the organic EL element 63 so as to detect charges pre-stored in the capacitor 131. In the embodiment, the charges stolen by the light irradiation of the organic EL element 63 corresponds to the light intensity sensor output serving as the basis.

In this case, timing chart (a) in FIG. 12 shows the charge state (charging state) of the capacitor 152 in the charge amplifier 150, timing chart (b) in FIG. 12 shows the operation of the selection transistor 132, timing chart (c) in FIG. 12 shows the lighting timing of the organic EL element 63, timing chart (d) in FIG. 12 shows the potential difference (Vₛ) across the capacitor 131, timing chart (e) in FIG. 12 shows the output voltage (Vᵣ₀) of the amplifier 151, timing chart (f) in FIG. 12 shows the operation of reading the output voltage (Vᵣ₀) by the ADC 160, and timing chart (g) in FIG. 12 shows a state where valid light intensity measurement data is finally acquired.

First, when ON signal is received at a predetermined timing from the selection signal generation circuit 140 through the selection line SelX, the selection transistor 132 is turned on (see (b) in FIG. 12 for reference). Then, as shown in (d) of FIG. 12, the capacitor 131 is charged and an initial voltage V_{ref} is generated across the capacitor 131 (S1: reset step).

When the selection transistor 132 is turned off (see (b) in FIG. 12 for reference), the charges charged in the capacitor 131 is discharged and decreased with photo current Is flowing through the light intensity sensor 57. Then, as shown in (d) of FIG. 12, the initial voltage V_{ref} of the capacitor 131 decreases gradually (S2: light irradiated discharging step).

When a predetermined time period has expired in this state, the charging/discharging selection transistor 153 of the charge amplifier 150 is turned off (see (a) of FIG. 12 for reference) allowing the charges in the capacitor 152 to move. Then, the charge amplifier 150 becomes able to measure the light intensity of the organic EL element 63 (S3: measurement start step).

At the turning off time of the charging/discharging selection transistor 153, the selection transistor 132 is turned on (see (b) of FIG. 12 for reference) and the charges are supplied from the capacitor 152 of the charge amplifier 150 to the capacitor 131 in which the charges have been stolen in step S2. As a result, the initial voltage V_{ref} is generated again across the capacitor 131 (see (d) in FIG. 12 for reference), and the output voltage Vᵣ₀ of the amplifier 151 of the charge amplifier 150 increases as shown in (e) of FIG. 12 (S4: charge transfer step). In this period, the photo current of the light intensity sensor 57 flows and the output voltage Vᵣ₀ increases.

Then, the selection transistor 132 is turned off again and the output voltage Vᵣ₀ is settled. When the settled voltage is read out by the ADC 160 in synchronization with the read signal (see (f) of FIG. 12 for reference), the operation of reading the valid light intensity measurement data is completed as shown in (g) of FIG. 12 (S5: read step).

In view of reducing the standby time of the image forming apparatus, it is desirable that the time period corresponding to the steps S2 and S3, i.e., the period between the turning OFF time of the charging/discharging selection transistor 153 of the charge amplifier 150 and the turning ON time of the selection transistor 130 is set to as short as possible. However, in view of securing a certain level of SN and some degree of voltage detection resolution, it is desirable to set the output voltage Vᵣ₀ as high as possible. In this case, it is necessary to secure the accumulation time period as great as possible. Accordingly, the accumulation time period is set in consideration of both view points. The accumulation time period is determined on the basis of the lighting period and blinking times of the organic EL element 63 (see (c) of FIG. 12 for reference), the number of light intensity sensors in the above-mentioned operation sequence (1), and the number of groups.

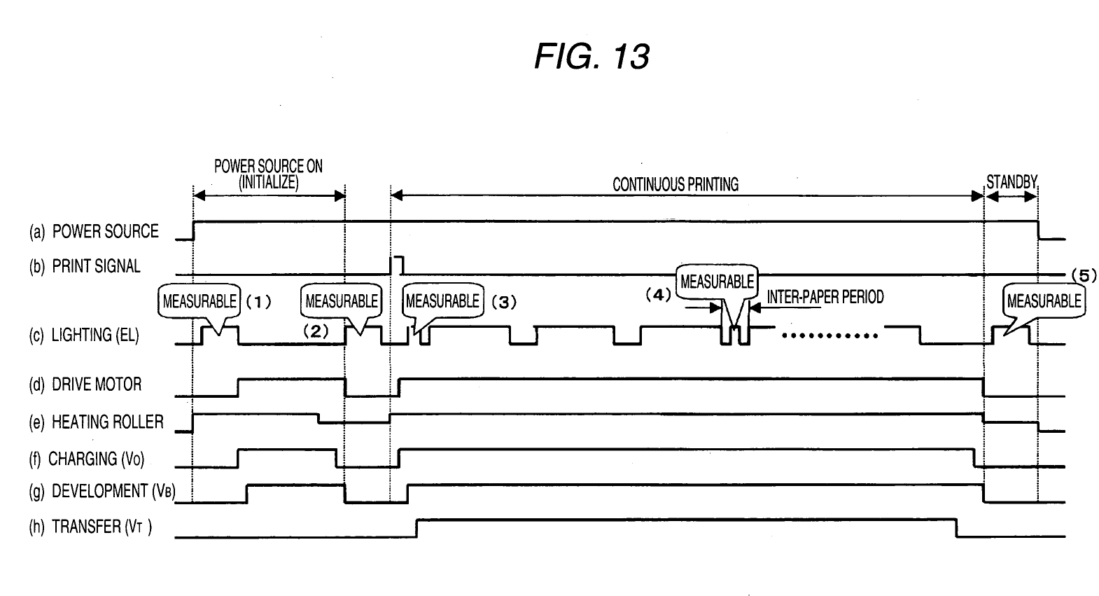

FIG. 13 is an example of various timings for measuring the light intensity of the organic EL-element at the time of correcting the light intensity. FIG. 13 shows a case where the timings for performing the light intensity measuring operation as a part of the light intensity correcting operation are set in three periods, i.e., in the initialization process of the image forming apparatus, in a continuous printing process, and in a standby mode. The symbol (1) in FIG. 13 corresponds to the light intensity measurement in the initialization process, the symbols (3) and (4) correspond to the light intensity measurement in the continuous printing process, and the symbol (5) corresponds to the light intensity measurement in the standby mode. The symbol (2) corresponds to the light intensity measurement in a period between the initialization process and the continuous printing process.

The initialization process is a process in which the image forming apparatus prepares for a printing operation after the power ON time. In the initialization process, a step (a) of powering ON and a step (e) of heating the heat roller are performed simultaneously. Thereafter, a step (d) of driving the drive motor (not shown) of the photosensitive member and a step (f) of charging the surface of the photosensitive member by the charger (generation of charging potential V₀) are performed simultaneously. In addition, a step (g) of applying the development bias potential V_{B} to the developing agent is performed by the development station.

When the organic EL elements 63 are lighted at the execution (ON) time of the steps (d), (f), and (g), the surface of the photosensitive member exposed by the lighting is set to the exposure potential V_{L} and the developing agent is made possible to move onto the photosensitive member. In order to prevent the contamination of the recording paper due to the decrease of the development agent, the operation of measuring the light quantity of the organic EL element is not performed at the execution time of the steps (d), (f), and (g). That is, the elements are not lighted. In this example, the light intensity measurement (1) is performed by lighting the organic EL elements prior to steps (d) and (f). The light intensity measurement (2) and (5) can be performed in the same manner.

The light intensity measurement (3) and (4) can be performed in the continuous printing process. Although the steps (d), (f), and (g) are performed in the period between (3) and (4), since the recording paper is not conveyed thereto, it may be considered that the light intensity measurement can be performed.

Next, deterioration (lifetime) of the organic EL elements with the lapse of time to be solved by the invention will be described.

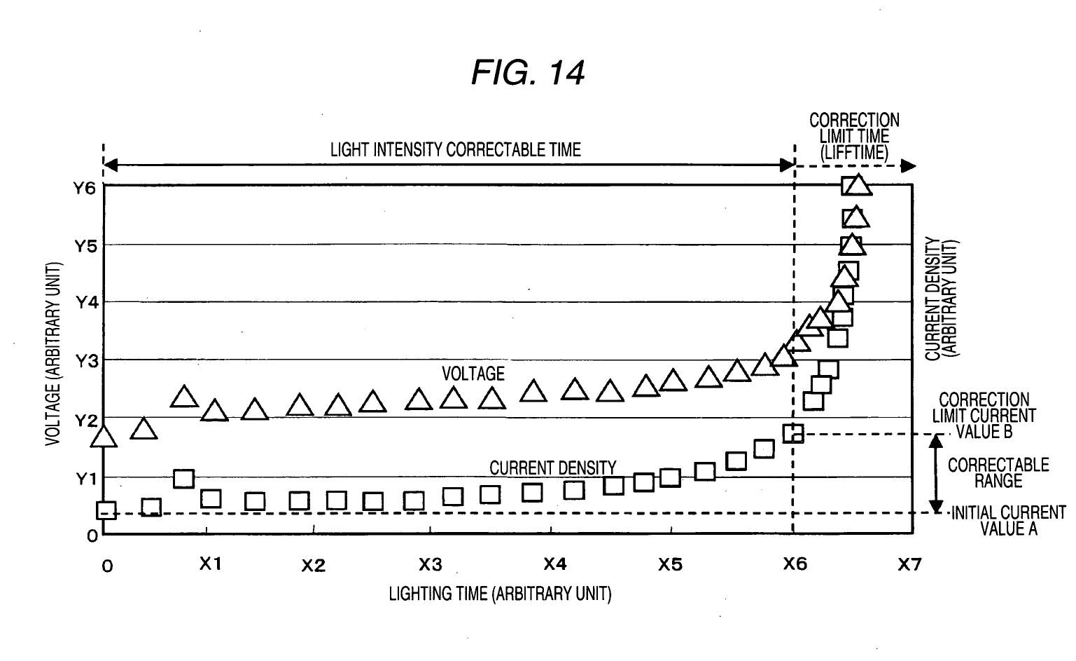

FIG. 14 is a graph showing a measurement result of a voltage applied to an organic EL element required for lighting the element with a constant light intensity (for example, 12000 [cd/m²]) and a current density (current) flowing through the element. As can be seen from the graph, when the organic EL element is driven with a constant voltage (so-called constant voltage driving) or with a constant current (so-called constant current driving), it has been known that so-called light intensity deterioration is found in the organic EL elements, i.e., the brightness gradually decreases with the driving of the organic EL element. Like in this example, the organic EL elements installed in the image forming apparatus require a brightness of 10000 [cd/m²] or more, thereby making strict driving condition of high voltage and large current.

In the above-mentioned image forming apparatus, it is necessary to control the light intensity (brightness) of the organic EL elements in the exposure device to be equal to each other in order to make the exposure light intensity on the photosensitive member equal to each other. As described above, since the light intensity of the organic EL elements gradually decreases with the driving, the values of the voltage and the current (current density) applied to the organic EL element of which the light intensity has decreased with the lapse of time are controlled to be increased.

However, since there is a limit in increasing the current value and it is difficult to increase the current value to a value equal to or greater than a certain limit current value, it becomes actually impossible to perform a light intensity increasing correction operation to the element having reached such a limit current value. In such a situation, it is difficult to form the electrostatic latent image on the photosensitive member and it is thus necessary to stop an engine or the apparatus at that moment. Particularly, when such a situation arises during the printing operation, it is unable to perform a subsequent printing operation, thereby making the treatment inconvenient.

Therefore, the invention aims to provide an image forming apparatus capable of preventing an abrupt stoppage of an engine or an apparatus even when a light emitting element fell into a state that the light intensity thereof cannot be corrected, thereby improving usability of the image forming apparatus, by (1) detecting the light emitting element having fallen into the state the light intensity thereof cannot be corrected and (2) detecting the relation between the current and the light intensity for driving the light emitting element. Hereinafter, various kinds of embodiments for achieving such an advantage will be described.

### First Embodiment

As described with reference to the graph in FIG. 14, although the current value required for obtaining a predetermined light intensity increases with the light emitting time period, it is difficult to correct the light intensity when driven with a predetermined current value or more. Accordingly, in the present embodiment, the predetermined current value is defined as a correction limit current value, and the light emitting element having reached the correction limit current value is excluded from the objects of the light intensity correction operation and is not subjected to the light intensity correction operation.

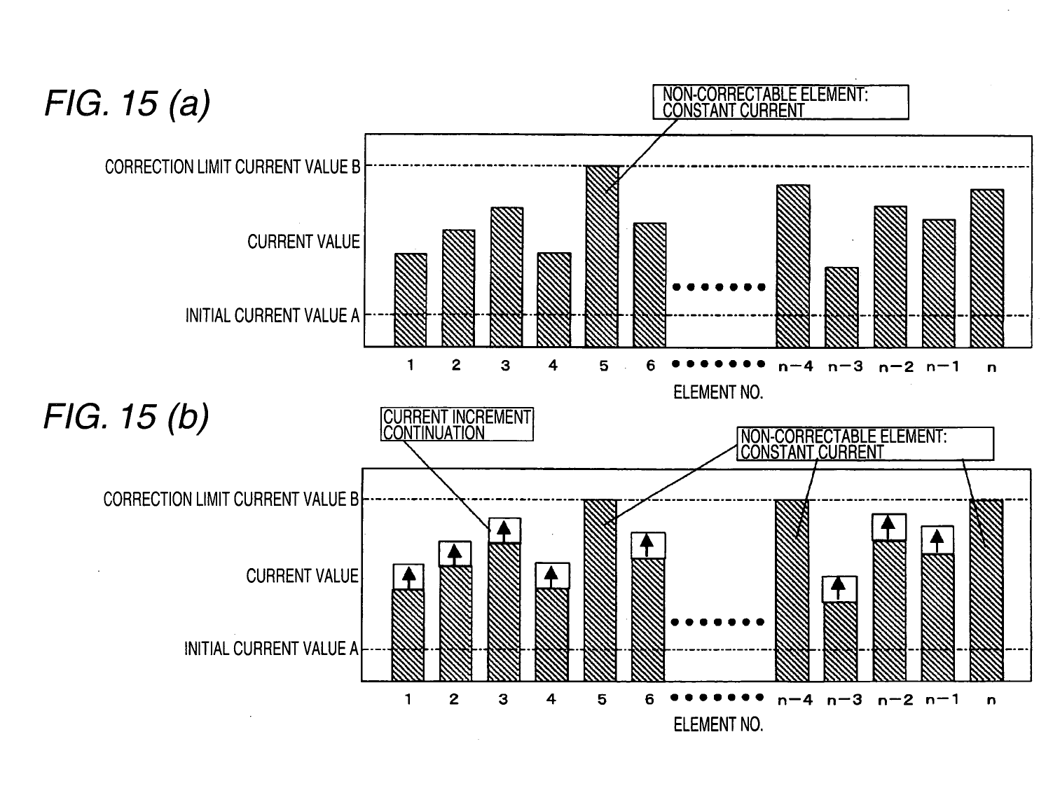

FIG. 15A is a conceptual graphic diagram showing a difference between current values for the light emitting elements (No. 1 to No. n). As can be seen from the graph, since variation in the light intensity deterioration of each of the light emitting elements with the lapse of time is different from each other, one light emitting element (No. 5 in FIG. 15A) may have reached the correction limit current value but the other light emitting element may not have reached the correction limit current value. In such a case, the light intensity correcting operation is performed to the light emitting element having reached the correction limit current value so that the light intensity thereof is controlled independently of the other light emitting elements. The light emitting element having reached the correction limit current value is defined as “correction limit light emitting element.”

As shown in FIG. 15B, although the value of current flowing through each of the light emitting elements increases after a further lapse of time, the light emitting element No. 5 still remains at the correction limit current value B. In this example, the light emitting elements No. n-4 and No. n have reached the limit value B. In this case, these elements remain at the correction limit current value B and are not subjected to the light intensity correcting operation. The current values of the other light emitting elements are increased with the lapse of time as illustrated by arrows in order to continue to perform the light intensity correcting operation.

In such a control, since it is impossible to further perform the light intensity correcting operation to the light emitting elements having reached the correction limit current value B, it is predicted that the light intensity of those elements decreases with the lapse of time. Therefore, since it is possible to prevent an abrupt stoppage of an engine or the apparatus even though it may involve some problem in view of the printing quality, it is possible to improve the usability.

Next, specific configuration of the present embodiment will be described. In the present embodiment, the current value of each of the light emitting elements is detected, and it is necessary to determine whether the current value has reached the correction limit current value. As the current value, the data ND set to the above-mentioned light intensity correction data memory 66 is used. This is because the data ND is the current value (driving current) set to the individual pixel circuit and the current value of the light emitting element.

As described above, the controller CPU 83 (the light intensity correction unit) of the controller 41 generates the light intensity correction data ND[n] and transmits the light intensity correction data ND[n] to the D/A converter (DAC) 72 of the source driver 61 through the printer interface 87 and the engine control unit 42. In the present embodiment, even when there is any light intensity correction data ND[n] having a value greater than the correction limit current value, the D/A converter 72 allows the correction limit current value to flow through the light emitting elements (No. 5, No. n-4, n and No. n in FIG. 15B) corresponding to the data.

More specifically, the intensity data includes the data ND[n] calculated by Equation 1 as 2 byte data and additional 1-byte data. When the calculation result of ND[n] is equal to or greater than 0x100 (hexadecimal form), the calculation result is clipped to 0x0ff (hexadecimal form). Since the computation is performed by the controller CPU 83, it can be easily achieved by selecting 2-byte register for the computation in the stage of program design.

While the correction limit current value may be determined in various methods, from the view point of hardware, it can be said that the maximum current value which can be supplied by the source driver 61 is “the correction limit current value.” However, the driving current based on the computational upper limit value within the maximum rating of the source driver 61 may be defined as “the correction limit current value.” In fact, the plurality of D/A converters 72 installed in the source driver 61 are set to the output current values (the light intensity correction data ND[n]) different from each other. However, since the relation of the output current values is all the same at every D/A converters 72, “the computational upper limit value” is set to the entire D/A converters 72 and the maximum output value of each of the D/A converters 72 may be treated to be constant. Moreover, in consideration of the system configuration of the source driver 61, it may be possible to a single “correction limit current value.”

In a practical device design, first, the initial current value A and the correction limit current value B are determined in consideration of the maximum rating of the source driver 61 and the property of the organic EL element 63. The initial current value A may be determined in consideration of the unevenness of the light quantity of the light emitting elements, for example, by providing some extents of margin (as little as possible when it is desired to secure throughput). The correction limit current value B may be determined as the current value corresponding to 90% of the maximum rating of the source driver 61. Moreover, a correction precision a (%) is determined on the basis of a target specification required in the device. Next, a correction step number S is calculated on the basis of Equation 2.
B=A×a/100×S Equation 2

Here, B represents the correction limit current value, A represents the initial current value, a represents the correction precision, and S represents the correction step number. The correction step number S is calculated by 2ⁿ−1 assuming that n is a correction bit number (the bit number of correction target data). Here, 2ⁿ corresponds to a data amount of each of the light emitting elements in each area (especially, third area) of the light intensity correction data memory 66 and is embodied as 8-bit data in the above-mentioned basic embodiment. However, depending on the required correction precision, the practically necessary correction step number may exceed the number value that can be expressed with 8-bit. For example, when the correction precision a is 0.5[%], the correction limit current value B is 500 [μA], and the initial current value A is 200 [μA], the correction step number S is calculated as 500 by Equation 1 and exceeds the step number coverable by 8-bit. In this case, it is necessary to construct the data structure of the third area in 16-bit unit in advance. In addition, depending on the correction step number S, the performance (for example, resolution) of the D/A converter 72 of the source driver 61 and a specification of the setting register of the D/A converter 72 are required to have conformity suitable to the bit number.

In the example in which the step number S is 500, it may be simple to construct the third area shown in FIG. 6 in the 16-bit configuration. Since allocating unnecessary bit number to the D/A converter 72 of the source driver 61 may have influence on the chip size, such a method is not advantageous method and therefore the setting register of the D/A converter 72 is constructed in a 9-bit configuration. Since the maximum value expressible with the 9-bit configuration is “511,” the above-mentioned clipping is not performed and it is determined whether the value calculated with ND[n] using Equation 1 has reached the correction limit current value. That is, in this example, when the calculation result of ND[n] has reached 500 (correction step number S), it is determined that it has reached the correction limit current value.

That is, when the correction step number consumed to correct into the desired light intensity correction data ND[n] has reached a preset number S (which is determined by the bit number of the area in the light intensity correction data memory 66), the light intensity correction data ND[n] is determined as the correction limit current value.

In this way, according to the present embodiment, even when there is any light emitting element having reached the correction limit current value, the light emitting element is excluded from the objects of the light intensity correction operation and the light intensity correcting operation is performed to other light emitting elements. Accordingly, it is possible to provide an image forming apparatus capable of preventing an abrupt stoppage of an engine or the apparatus and improving the usability.

In the above example, when the calculation result of the ND[n] has reached the correction step number S, it is determined that it has reached the correction limit current value. However, since the correction limit current value has a margin of “90% of the maximum rating of the source driver 61”, there is a margin with respect to the maximum rating of the source driver even when it actually has reached the correction limit current value. In addition, there is a margin until reaching the upper limit of the 9-bit setting in the D/A converter 72.

Therefore, when it is determined on the basis of the correction step number S that it has reached the correction limit current value, the light intensity correcting operation may be performed with exceeding the correction limit current value while displaying on the operation panel 98 of the image forming apparatus that a replacement period of the exposure device 13 has reached. Thereafter, when the calculated value of ND[n] has reached the setting upper limit of the D/A converter 72 for example, the digital data is clipped and the light emitting element may be excluded from the object of the light intensity correcting operation (i.e., the light intensity correcting operation is not performed).

### Second Embodiment

In the present embodiment, when the light emitting element (correction limit light emitting element) having reached the correction limit current value is detected, the light intensity of the light emitting elements other than the correction limit light emitting element is corrected on the basis of the light intensity of the correction limit light emitting element. For example, in the example of FIG. 15A, the current values of the light emitting elements other than the correction limit light emitting element are adjusted on the basis of the light intensity of the light emitting element No. 5 so that the light intensity of other light emitting elements is equal to that of the correction limit light emitting element.

The light intensity measurement data of the entire light emitting elements detected by the light intensity sensor 57 is written to the second memory of the light intensity correction data memory 66. As described in the first embodiment, it can be seen that the current value of the light emitting element No. 5 has reached the correction limit current value. Therefore, the controller CPU 83 of the controller 41 generates the light intensity correction data ND[n] such that the light intensity measurement data ID of the other light emitting elements becomes equal to the light intensity measurement data ID[5] of the light emitting element No. 5.

In this case, the controller CPU 83 transmits provisional light intensity correction data ND to the D/A converter (DAC) 72 of the source driver 61 and the light intensity sensor 57 detects the light intensity obtained with the light intensity correction data ND. The light intensity measurement data ID is generated on the basis of the detection. By repeating these operations, it is possible to make the light intensity of other light emitting elements equal to that of the light emitting element No. 5.

In the example of FIG. 15B, although there is a plurality of light emitting elements having reached the correction limit current value, the light emitting element becoming the basis of the correction may be arbitrarily selected. For example, the correction may be based on the light emitting element having the smallest light intensity.

### Third Embodiment

In the above-mentioned second embodiment, the light intensity of other light emitting elements is corrected on the basis of the light intensity of the light emitting element having reached the correction limit current value. Here, the fact that it has reached the correction limit current value implies that the driving current value does not increase any further. Therefore, the light intensity of the light emitting element of which the driving current value has reached the correction limit current value may decrease with the lapse (accumulation) of lighting period. When the light intensity of the light emitting element is used as the basis of the light intensity correction, the whole light intensity of the exposure device 13 may decrease. In this situation, since it is impossible to obtain substantially low exposure potential due to the decrease in the exposure light intensity (the difference between the development bias potential and the exposure potential decreases), it is made difficult to supply a sufficient amount of developing agent from the development station 2 to be adhered to the photosensitive member 8, thereby deteriorating the printing quality.

Therefore, in the present embodiment, it aims to maintain good printing quality by maintaining the post-exposure potential at a substantially low value even when the whole light intensity of the exposure device 13 has decreased.

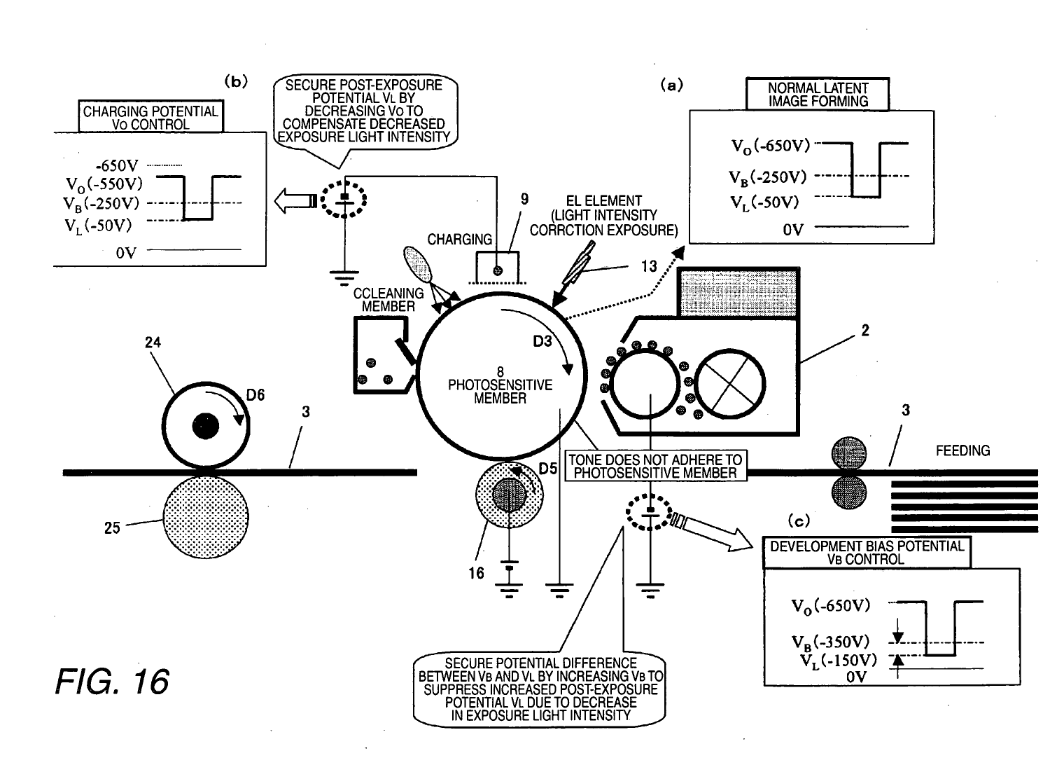

FIG. 16 is a schematic diagram showing the arrangement of the present embodiment. As shown in (a) of FIG. 16, in a normal printing, the surface potential V₀ of the photosensitive member 8 (the charging-potential by the charger) is set to −650 V, the development bias potential V_{B} (the voltage generated between the photosensitive member 8 and the development station at the time of visualizing the electrostatic latent image using the developing agent, i.e., the potential of the development sleeve 10) is set to −250 V, and the exposure potential V_{L} corresponding to the potential of the portion (electrostatic latent image) of the photosensitive member exposed by the exposure device 13 is set to −50 V.

When the whole light intensity of the exposure device 13 has decreased, it may be difficult to obtain a sufficiently low exposure potential V_{L} such as −50 V, as described above. In the present embodiment, as shown in (b) of FIG. 16, while maintaining the development potential V_{B} at a normal value of −250 V, the charging potential V₀ of the photosensitive member 8 by the charger 9 is set to −550 V having an absolute value smaller than the normal value of −650 V. That is, the charging potential of the photosensitive member 8 by the charger 9 is controlled with reference to the exposure potential V_{L} of the electrostatic latent image corresponding to the light intensity of the correction limit light emitting element. In this way, it is possible to secure sufficiently low exposure potential such as −50 V and thus secure a sufficient difference −200 V (=−250+50) between the development bias potential V_{B} and the exposure potential like in the normal case. Therefore, it is made possible to supply a sufficient amount of developing agent from the development station 2 to be adhered to the photosensitive member 8, thereby maintaining the printing quality.

The above-mentioned advantage may be achieved by setting the development bias potential V_{B} to −350 V having an absolute value greater than the normal value of −250 V, as shown in (c) of FIG. 16. That is, when the light intensity of the exposure device 13 is small, it may be difficult to obtain the normal exposure potential as sufficiently low as 50 V (−150 V in this example). However, by increasing the absolute value of the development bias potential V_{B}, it is made possible to secure a sufficient difference −200 V (=−350+150) between the development bias potential V_{B} and the exposure potential like in the normal case. That is, the development bias V_{B} potential by the development station 2 is controlled with reference to the exposure potential V_{L} of the electrostatic latent image corresponding to the light intensity of the correction limit light emitting element. Therefore, it is made possible to supply a sufficient amount of developing agent from the development station 2 to be adhered to the photosensitive member 8, thereby maintaining the printing quality.

In addition, in the first to third embodiments, when the driving current value of the light emitting element has reached the correction limit current value, the image forming apparatus may output an alarm signal to a user. For example, the engine control CPU 91 of the engine control unit 42 may display the alarm signal on a liquid crystal display provided as an alarm device to the operation panel 98. As the alarm signal, an alarming for informing the replacement of a printer engine or a head device may be considered. The alarm device is not limited to the display, but may be an audio device and may be configured such that the alarm signal is transmitted to the host computer 80 (see FIG. 5 for reference) through the network 81 when the image forming apparatus is connected to the network.

### Fourth Embodiment

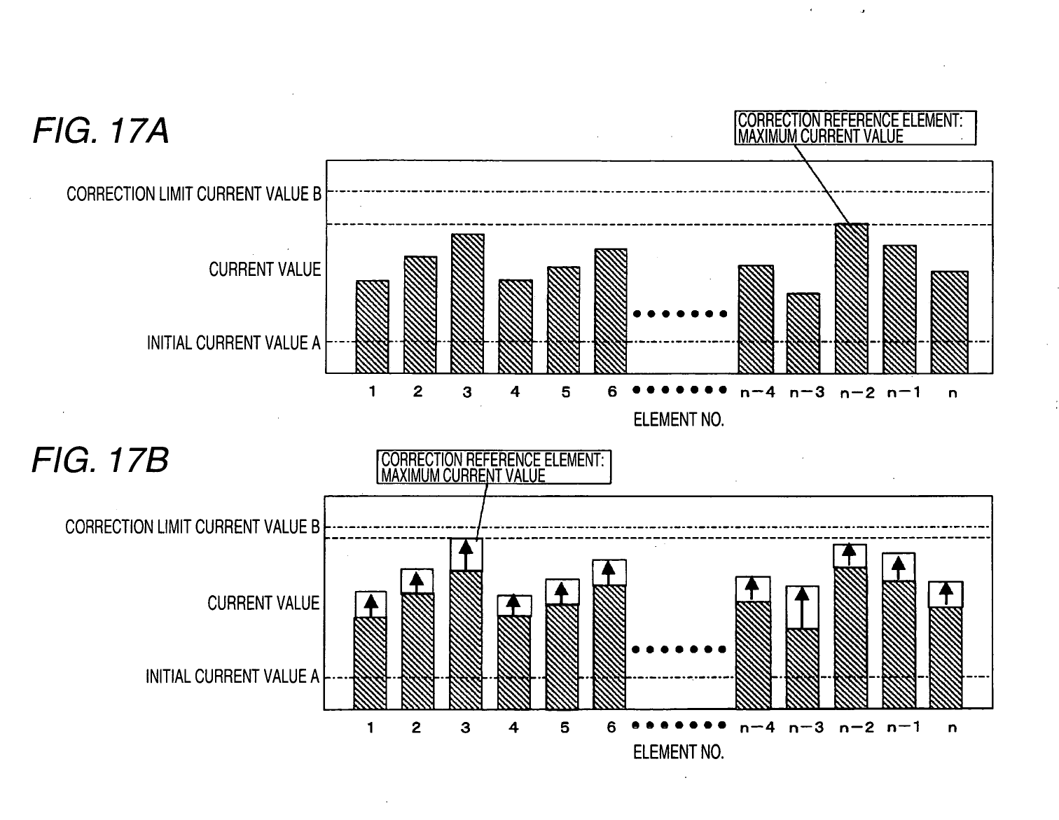

In the present embodiment, the driving current value of each of the light emitting elements is detected, and the light intensity of other light emitting elements is corrected on the basis of the light intensity of the light emitting element having the greatest driving current value. For example, in the example of FIG. 17A, the current values of other light emitting elements are adjusted on the basis of the light intensity of the light-emitting element No. n-2 so that the light intensity of the other light emitting elements is equal to that of the light emitting element No. n-2. The light emitting element having the greatest driving current value is defined as “the reference light emitting element” serving as the reference of the light intensity correcting operation.

If the light emitting element having the greatest driving current value is not selected as the reference light emitting element, the light emitting element may be supplied with driving current having even greater value, thereby deteriorating the light emitting element. However, by selecting the light emitting element having the greatest driving current value as the reference light emitting element, the deterioration of the light emitting element is prevented as much as possible.

Moreover, it may be possible that other light emitting element has the greatest driving current value with the lapse of time. For example, FIG. 17B shows the current value after the lapse of a predetermined time period from the example of FIG. 17A. In this case, the light emitting element No. 3 other than No. n-2 has the greatest driving current value. Therefore, in this case, the current values of other light emitting elements are adjusted on the basis of the light intensity of the light emitting element No. 3 so that the light intensity of the other light emitting elements is equal to that of the light emitting element No. 3.

In addition, in this example, it is unnecessary to maintain the light intensity of the light emitting element having the greatest driving current value at the light intensity obtained at that moment. For example, in the example of FIG. 17A, the light intensity of the light emitting element No. n-2 may be set to another light intensity (a second light intensity), and the current values of the other light emitting elements may be controlled to have the another light intensity.

It is desirable to set the second light intensity to a value smaller than that of at the time of detecting the greatest driving current. In this way, it is possible to prevent the deterioration of the light emitting element as much as possible. Although decreasing the light intensity of the reference light emitting element may decrease the whole light intensity of the exposure device, such a defect may be prevented by controlling the charging potential of the photosensitive member 8 or the development bias potential V_{B}, as described (see FIG. 16 for reference).

### Fifth Embodiment

In the present embodiment, the light emitting element having the smallest light intensity when the entire light emitting elements are driven with the same driving current is selected by considered it as the light emitting element having the greatest driving current when the entire light emitting elements are lighted with the same light intensity. In general, since the light intensity of the organic EL element decreases with the deterioration of the element, the driving current, the driving voltage, or the driving time period is increased to correct the decreased light intensity. Therefore, it may be regarded that the darkest light emitting element having the smallest light intensity when the entire light emitting elements are driven with the same driving condition is set to the greatest driving current, voltage or time period.

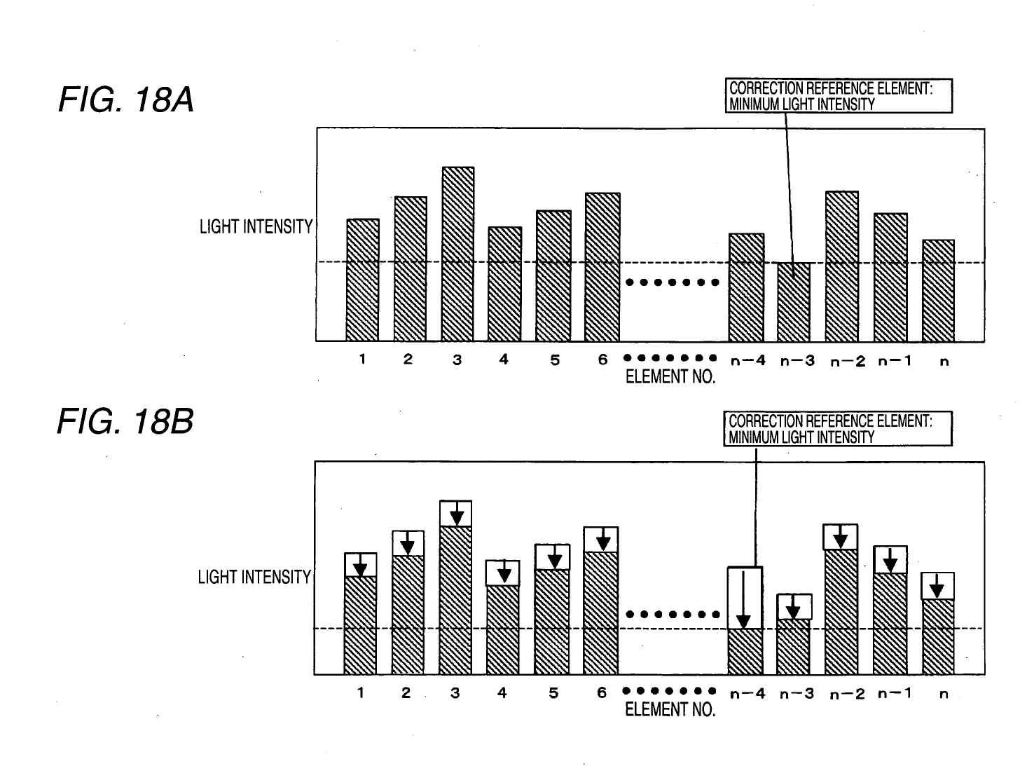

For example, in the example of FIG. 18A, the current values of other light emitting elements are adjusted on the basis of the light intensity of the light emitting element No. n-3 so that the light intensity of the other light emitting elements is equal to that of the light emitting element No. n-3, assuming that the light emitting element No. n-3 has the greatest driving current. The light emitting element having the smallest light intensity is defined as “the reference light emitting-element” serving as the reference of the light intensity correcting operation.

Moreover, it may be possible that other light emitting element has the smallest light intensity with the lapse of time.

For example, FIG. 18B shows the light intensity after the lapse of a predetermined time period from the example of FIG. 18A. In this case, the light emitting element No. n-4 other than No. n-3 has the smallest light intensity. Therefore, in this case, the current values of other light emitting elements are adjusted on the basis of the light intensity of the light emitting element No. n-4 so that the light intensity of the other light emitting elements is equal to that of the light emitting element No. n-4.

In the fourth and fifth embodiments, it is also possible to provide an image forming apparatus capable of preventing an abrupt stoppage of an engine or the apparatus and improving the usability. In addition, since the correcting operation is performed with reference to the light intensity of the light emitting element always requiring the greatest driving current (having the smallest light intensity), the correction computation is all the same regardless of the presence and absence of the light emitting element having reached the correction limit current value, thereby simplifying the control.

To the contrary, in a system in which the light intensity of the light emitting elements of the exposure device is corrected using the light emitting element having the greatest light intensity in the same driving condition as the reference light emitting element, the light emitting elements other than the reference light emitting element is driven on the basis of greater driving current, voltage, or time period compared with the reference light emitting element, thereby accelerating the deterioration. As a result, some of the light emitting elements other than the reference light emitting element may reach the correction limit. The light intensity of the light emitting elements having reached the correction limit cannot be further increased due to the restriction of the driver's specification, for example. When left in that state, the light emitting elements having reached the correction limit may be further deteriorated and thus have severe influence on the image quality of the image forming apparatus.

An algorithm in which “the light emitting element having the smallest light intensity” is selected as the reference light emitting element when detecting the light emitting element having reached the correction limit may be contemplated. However, in this case, “the reference light emitting element” itself is changed depending on the presence and absence of the light emitting element having reached the correction limit. Consequently, it may change the algorithm of correcting the light intensity and it is thus undesirable in view of a system design

Accordingly, as described in the present embodiment, it is a best solution to select the light emitting element having the greatest driving current value or the light emitting element having the smallest light intensity when driven in the same driving condition as the reference light emitting element.

In addition, in the fourth and fifth embodiments, similar to the third embodiment, it is possible to control the charging potential of the photosensitive member and the development bias potential, as shown in FIG. 6. That is, in the fourth and fifth embodiments, similar to the third embodiment, since the whole light intensity of the exposure device is likely to decrease, it is possible to secure sufficiently low exposure potential by controlling the charging potential and the development bias potential.

In addition, in the fourth and fifth embodiments, similar to the first to third embodiments, the alarm signal may be output to the user by the image forming apparatus in a certain occasion. For example, the alarm signal may be output when the driving current of the light emitting element having the greatest driving current has reached a predetermined current value.

The embodiments have been described with reference to an arrangement in which the lighting periods of the organic EL elements 63 constituting the exposure device 13 are set to a constant period and the light intensity of the organic EL elements 63 is controlled by changing the current value. However, the invention may be easily applied to a so-called PWM method in which the driving current value of the light emitting element such as the organic EL element 63 is set to a fixed value and the light intensity of the light emitting element is controlled by changing the lighting period. In this case, the content of the first area described with reference to FIG. 6 may be substituted by “the setting value of the driving period for making the cross sectional areas the latent images equal to each other.”

That is, in the above-mentioned embodiments, the driving condition for the organic EL element 63 as the object of the light intensity correcting operation was the current value. The driving voltage and the driving period (PWM) may be selected as the driving condition for the object of the light intensity correcting operation. Moreover, it may be possible to control the voltage applied to the organic EL element 60 or perform the PWM control for controlling the ON time (duty rate) in a predetermined raster period (one line forming period).

In addition, there is known an exposure device which forms the latent image by exposing multiple times those portions having substantially the same relation to the rotation direction of the photosensitive member using a plurality of light emitting element arrays constituted by the organic EL elements. The invention may be applied to such an exposure device by setting the light intensity of the PWM period so that the latent images formed through the multiple times of exposure do not contribute to the development. In such an exposure device, since the latent image contributing to the development is not formed in the case of a single array type light emitting element, a sequence in which the light intensity may be measured in the inter-paper period in units of an array may be considered.

In addition, in the embodiments, although the light intensity of the organic EL element 63 is measured using the light intensity sensor constituted by a monolithic poly-silicon device like the TFT circuit and the organic EL element, the technical scope of the invention is not limited to this. For example, the invention may be applied to a case where a plurality of light intensity sensors made of amorphous silicon is formed into a film configuration and arranged along an end face of the glass substrate 50.

As described above, although the embodiments have been described with reference to the image forming apparatus employing an electro-photographic method, the invention is not limited to the electro-photographic method. Since the RGB light source can be realized by the organic EL element, the invention may be employed in an image forming apparatus in which a plurality of exposure devices having light sources corresponding to R, G, and B colors is provided as an exposure light source so as to directly expose a photographic paper on the basis of image data corresponding to each color of R, G, and B.

While the invention has been described with reference to the embodiments, the invention is not limited to the above embodiments. However, various modifications can be made on the basis of the whole description of the specifications and the known technologies. Such modifications are also included in the technical scope of the invention.

As described above, according to the image forming apparatus related to the invention, it is possible to prevent an abrupt stoppage of an engine or an apparatus even when there is any light emitting element (lifetime element) having reached the correction limit, particularly in an electro-photographic device. Accordingly, the image forming apparatus can be used in a printer, a copying machine, a facsimile machine, a photo printer, and the like, for example.

This application is based upon and claims the benefit of priority of Japanese Patent Application No 2006-088630 filed on Jun. 3, 1928, the contents of which is incorporated herein by references in its entirety.

1. An image forming apparatus, comprising:
an image carrier;
an exposure unit having a plurality of light emitting elements exposing the image carrier to light beams;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured to correct the light intensity of light emitted from the light emitting elements other than a reference light emitting element on the basis of the light intensity of light emitted from the reference light emitting element, using the light emitting element of which the driving condition is closet to a correction limit as the reference light emitting element.

2. An image forming apparatus, comprising:
an image carrier;
an exposure unit having a plurality of light emitting elements exposing the image carrier to light beams;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured to correct the light intensity of light emitted from the light emitting elements other than a reference light emitting element on the basis of the light intensity of light emitted from the reference light emitting element, using the light emitting element of which the driving condition has reached a correction limit as the reference light emitting element.

3. An image forming apparatus, comprising:
an image carrier;
an exposure unit having a plurality of light emitting elements exposing the image carrier to light beams;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured to correct the light intensity of light emitted from the light emitting elements other than a reference light emitting element on the basis of the light intensity of light emitted from the reference light emitting element, using the light emitting element of which the light intensity is smallest when the entire light emitting elements are driven with the same driving condition as the reference light emitting element.

4. An image forming apparatus, comprising:
an image carrier;
an exposure unit having a plurality of light emitting elements exposing the image carrier to light beams;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured not to correct the light intensity of light emitted from the light emitting element of which the driving condition satisfies a predetermined condition.

5. The image forming apparatus according to claim 1,
wherein the driving condition is a driving current for driving the light emitting elements.

6. The image forming apparatus according to claim 1,
wherein the driving condition is a driving voltage for driving the light emitting elements.

7. The image forming apparatus according to claim 1,
wherein the driving condition is a driving time for driving the light emitting elements.

8. An image forming apparatus, comprising:
a photosensitive member;
a charger charging a surface of the photosensitive member;
a plurality of light emitting elements irradiating light beams to the surface of the photosensitive member charged by the charger, thereby exposing the surface to the light beams so as to form an electrostatic latent image on the surface;
a development unit applying a developing agent onto the electrostatic latent image so as to develop the electrostatic latent image;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured not to, when there is at least one correction limit light emitting element of which the driving current value has reached a correction limit current value, correct the light intensity of light emitted from the correction limit light emitting element.

9. The image forming apparatus according to claim 8,
wherein the light intensity correcting unit maintains the driving current value of the correction limit light emitting element at the correction limit current value.

10. The image forming apparatus according to claim 8,
wherein the light intensity correcting unit corrects the light intensity of light emitted from the light emitting elements other than the correction limit light emitting element on the basis of the light intensity of light emitted from the correction limit light emitting element.

11. The image forming apparatus according to claim 10,
wherein the development bias potential of the development unit is controlled on the basis of the exposure potential of the electrostatic latent image corresponding to the light intensity of light emitted from the correction limit light emitting element.

12. The image forming apparatus according to claim 10,
wherein the charging potential of the charger for charging the photosensitive member is controlled on the basis of the exposure potential of the electrostatic latent image corresponding to the light intensity of light emitted from the correction limit light emitting element.

13. The image forming apparatus according to claim 10, further comprising an alarm device notifying the presence of the correction limit light emitting element.

14. The image forming apparatus according to claim 8,
wherein the light emitting elements are constituted by an organic EL (electroluminescence) element.

15. An image forming apparatus, comprising:
a photosensitive member;
a charger charging a surface of the photosensitive member;
a plurality of light emitting elements irradiating light beams to the surface of the photosensitive member charged by the charger, thereby exposing the surface to the light beams so as to form an electrostatic latent image on the surface;
a development unit applying a developing agent onto the electrostatic latent image so as to develop the electrostatic latent image;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured to correct the light intensity of light emitted from the light emitting elements other than a reference light emitting element on the basis of the light intensity of light emitted from the reference light emitting element, using the light emitting element of which the driving current value is greatest as the reference light emitting element.

16. The image forming apparatus according to claim 15,
wherein the light intensity correcting unit sets the light intensity of light emitted from the reference light emitting element to a second light intensity and corrects the light intensity of light emitted from other light emitting elements using the second light intensity.

17. The image forming apparatus according to claim 15,
wherein the development bias potential of the development unit is controlled on the basis of the exposure potential of the electrostatic latent image corresponding to the light intensity of light emitted from the reference light emitting element.

18. The image forming apparatus according to claim 15,
wherein the charging potential of the charger for charging the photosensitive member is controlled on the basis of the exposure potential of the electrostatic latent image corresponding to the light intensity of light emitted from the reference light emitting element.

19. The image forming apparatus according to claim 15, further comprising:
an alarm device notifying that the driving current value of the reference light emitting element has reached a predetermined current value.

20. The image forming apparatus according to claim 15,
wherein the light emitting elements are constituted by an organic EL element.

21. An image forming apparatus, comprising:
a photosensitive member;
a charger charging a surface of the photosensitive member;
a plurality of light emitting elements irradiating light beams to the surface of the photosensitive member charged by the charger, thereby exposing the surface to the light beams so as to form an electrostatic latent image on the surface;
a development unit applying a developing agent onto the electrostatic latent image so as to develop the electrostatic latent image;
a light intensity measuring unit measuring a light intensity of light emitted from the light emitting elements; and
a light intensity correcting unit setting a driving condition for the light emitting elements on the basis of the light intensity of light measured by the light intensity measuring unit, which is emitted from the light emitting elements,
wherein the light intensity correcting unit is configured to correct the light intensity of light emitted from the light emitting elements other than a reference light emitting element on the basis of the light intensity of light emitted from the reference light emitting element, using the light emitting element of which the light intensity is smallest when the entire light emitting elements are driven by the same driving current value as the reference light emitting element.

22. The image forming apparatus according to claim 21,
wherein the development bias potential of the development unit is controlled on the basis of the exposure potential of the electrostatic latent image corresponding to the light intensity of light emitted from the reference light emitting element.

23. The image forming apparatus according to claim 21,
wherein the charging potential of the charger for charging the photosensitive member is controlled on the basis of the exposure potential of the electrostatic latent image corresponding to the light intensity of light emitted from the reference light emitting element.

24. The image forming apparatus according to claim 21, further comprising an alarm device notifying that the driving current value of the reference light emitting element has reached a predetermined current value.

25. The image forming apparatus according to claim 21,
wherein the light emitting elements are constituted by an organic EL element.

26. The image forming apparatus according to claim 4,
wherein the predetermined condition is that a setting value to be set by the light intensity correcting unit corresponding to any one of a driving current value, a driving voltage value, and a driving time of the light emitting element has reached a predetermined value.

27. The image forming apparatus according to claim 1, wherein the correction limit is that a setting value to be set by the light intensity correcting unit corresponding to any one of a driving current value, a driving voltage value, and a driving time of the light emitting element has reached a predetermined value.
